(19) United States
(12) Patent Application Publication
(10) Pub. No.: US 2004/0179713 A1
(43) Pub. Date: Sep. 16, 2004

(54) Image processing method, image processing apparatus, and information processing apparatus

(76) Inventors: Kenji Tani, Yokkaichi-shi (JP); Kazuma Ogawa, Yamatokooriyama-shi (JP); Satoshi Tsubooka, Yamatokooriyama-shi (JP); Takashi Ide, Osaka (JP)

Correspondence Address: BIRCH STEWART KOLASCH & BIRCH, PO BOX 747, FALLS CHURCH, VA, 22040-0747, US

(21) Appl. No.: 10/796,181

(22) Filed: Mar. 10, 2004

(30) Foreign Application Priority Data
Mar. 11, 2003 (JP) 2003-65215
May 26, 2003 (JP) 2003-147647
Oct. 6, 2003 (JP) 2003-347482
Oct. 7, 2003 (JP) 2003-348631

(51) Int. Cl. G06F 17/00

(52) U.S. Cl. 382/100

(57) ABSTRACT

When an image reading section reads an original color document a confidential portion of which is prepared in a specific color, an image processing apparatus receives authentication information such as a password from an operation section, and thereby compares the received authentication information with user information stored in a storage section so as to perform authentication. When the authentication is not completed, a controlling section issues an output stop instruction for the specific color to a color restricting section. The color restricting section deletes a specific color portion in the image data received from the image reading section. The image data the specific color portion of which is deleted is transmitted to an image forming section, and then printed out on recording paper.

This Nonprovisional application claims priority under 35 U.S.C. §119(a) on Patent Application No. 2003-65215 filed in Japan on Mar. 11, 2003, Patent Application No. 2003-147647 filed in Japan on May 26, 2003, Patent Application No. 2003-347482 filed in Japan on Oct. 6, 2003 and Patent Application No. 2003-348631 filed in Japan on Oct. 7, 2003, the entire contents of which are hereby incorporated by reference.

### BACKGROUND OF THE INVENTION

The present invention relates to an image processing method, an image processing apparatus, and an information processing apparatus for preventing the unintentional copying, printing, or facsimile transmission of a confidential portion in a document.

Some image processing apparatuses for copying, printing, or facsimile transmission have the function of restricting the copying, printing, or facsimile transmission of a document having high confidentiality or importance. For example, an image processing apparatus and an image processing system (Japanese Patent Application Laid-Open 11-215351 (1999)) have been proposed in which a public key is embedded in a confidential or important document, and in which the copying of the document is not allowed without a corresponding secret key, so that the copying by many and unspecified users is avoided. Alternatively, an image processing apparatus (Japanese Patent Application Laid-Open 9-214782 (1997) and 3-198476 (1991)) has been proposed in which a document is copied with the exclusion of vermilion or the like portions, so that a copy is generated without stamp (seal) portions and without remarks in vermilion ink.

Nevertheless, in the image processing apparatus of Japanese Patent Application Laid-Open 11-215351 (1999), the entirety of a document is restricted in the copying. This causes the problem of degradation in convenience. For example, even in case that a document has high confidentiality or importance, not its entirety is necessarily confidential or important. In many cases, only a part of the document is confidential or important. That is, the confidentiality or importance merely in a part of the document restricts also the copying and the like of the other part of the document, so that the convenience is degraded. In the image processing apparatus and the like of Japanese Patent Application Laid-Open 9-214782 (1997) and 3-198476 (1991), the color the copying of which is inhibited is determined in advance. This causes a restriction in the number of colors allowed to be used in general documents, or alternatively causes the necessity of preparing the confidential or important portion into the predetermined color. As such, the problem of degradation in convenience is caused.

### BRIEF SUMMARY OF THE INVENTION

The invention has been devised with considering the above-mentioned problems. An object of the invention is to provide an image processing method, an image processing apparatus, and an information processing apparatus capable of improving the convenience in the preparation and handling of a confidential or important document serving as a target of output stopping during the copying, printing, or facsimile transmission thereof, and still capable of maintaining a high security level.

Another object of the invention is to provide an image processing apparatus capable of clearly notifying to a user that a confidential portion (specific color portion) has intentionally not been outputted.

Yet another object of the invention is to provide an image processing method and an image processing apparatus in which specific color information concerning a specific color is acquired, so that the specific color can be changed for each image data, so that the degree of freedom in the color used in a confidential or important portion is increased.

Yet another object of the invention is to provide an information processing apparatus in which image data, together with specific color information concerning a specific color, is transmitted to an image processing apparatus, so that a specific color can be specified for each image data, so that the degree of freedom in the color used in a confidential or important portion is increased.

An aspect of the invention is an image processing method which uses an image processing apparatus for receiving color image data so as to store the data into a storage section and then performing the output processing of the color image data stored in the storage section, the method comprising the steps of: authenticating the requestor of the output processing of the received color image data; and extracting a specific color portion of the received color image data, when the authentication is not completed; wherein the outputting of the extracted specific color portion is stopped.

An aspect of the invention is an image processing apparatus for receiving color image data so as to store the data into a storage section and then performing the output processing of the color image data stored in the storage section, the apparatus comprising: authenticating means for authenticating the requestor of the output processing of the received color image data; extracting means for extracting a specific color portion of the received color image data, when the authentication is not completed in the authenticating means; and output stopping means for stopping the output of the specific color portion extracted by the extracting means.

According to the invention, the authenticating means authenticates the requestor of the output processing of received color image data. When the authentication is not completed in the authenticating means, the extracting means extracts a specific color portion of the received color image data. Then, the output stopping means stops the output of the extracted specific color portion. In many cases of preparing a document, ordinary portions are prepared in black or the like, while important portions are prepared in a specific color other than black. In the output processing of the image data containing the specific color, when the output requestor is authenticated, an image containing both the specific color portion (important portion) and the non-specific color portion (ordinary portion) is outputted. In contrast, when the output requestor is not authenticated, the non-specific color portion (ordinary portion) is solely outputted with the exclusion of the specific color portion (important portion). The image data can be received by reading the color image of an original document through a color scanner, or by receiving color image data or document data from a computer. The received image data can be printed out on recording paper or transmitted by facsimile. As described above, the outputting or the output stopping of the important portion (specific color portion) can be switched depending on the result of authentication. This improves the user convenience, and avoids that the copying, printing, or facsimile transmission of a document containing an important portion is carried out by many and unspecified persons.

An aspect of the invention is an image processing method which uses an image processing apparatus for receiving color image data so as to store the data into a storage section and then performing the output processing of the color image data stored in the storage section, the method comprising the steps of: authenticating the requestor of the output processing of the received color image data; and extracting a specific color portion of the received color image data; wherein when the authentication is not completed, the outputting of the extracted specific color portion is stopped.

An aspect of the invention is an image processing apparatus for receiving color image data so as to store the data into a storage section and then performing the output processing of the color image data stored in the storage section, the apparatus comprising: authenticating means for authenticating the requester of the output processing of the received color image data; extracting means for extracting a specific color portion of the received color image data; and output stopping means for stopping the output of the specific color portion extracted by the extracting means, when the authentication is not completed in the authenticating means.

According to the invention, the authenticating means authenticates the requestor of the output processing of received color image data. The extracting means extracts a specific color portion of the received color image data. When the authentication is not completed in the authenticating means, the output stopping means stops the output of the extracted specific color portion. In the output processing of the image data containing a specific color, when the output requestor is authenticated, an image containing both the specific color portion (important portion) and the nonspecific color portion (ordinary portion) is outputted. In contrast, when the output requestor is not authenticated, the non-specific color portion (ordinary portion) is solely outputted with the exclusion of the specific color portion (important portion). As such, the outputting or the output stopping of the important portion (specific color portion) can be switched depending on the result of authentication. This improves the user convenience, and avoids that the copying, printing, or facsimile transmission of a document containing an important portion is carried out by many and unspecified persons. Further, the authentication and the extraction of the specific color portion are performed in parallel. This permits efficient output processing of the image data.

An aspect of the invention is an image processing apparatus for receiving color image data so as to store the data into a storage section and then performing the output processing of the color image data stored in the storage section, the apparatus comprising: instruction receiving means for receiving an output instruction or an output stop instruction for a specific color portion of the received color image data; extracting means for extracting the specific color portion of the received color image data, when the instruction receiving means receives the output stop instruction; and output stopping means for stopping the output of the specific color portion extracted by the extracting means.

According to the invention, the instruction receiving means receives an output instruction or an output stop instruction for a specific color portion. When the instruction receiving means receives the output stop instruction, the extracting means extracts the specific color portion of the received color image data, so that the output stopping means stops the output of the extracted specific color portion. In the output processing of the image data containing a specific color, when an output instruction is received, an image containing both the specific color portion (important portion) and the non-specific color portion (ordinary portion) is outputted. In contrast, when an output stop instruction is received, the non-specific color portion (ordinary portion) is solely outputted with the exclusion of the specific color portion (important portion). As such, the outputting or the output stopping of the important portion (specific color portion) can be switched depending on the result of authentication. This improves the user convenience.

An aspect of the invention is an image processing apparatus for receiving color image data so as to store the data into a storage section and then performing the output processing of the color image data stored in the storage section, the apparatus comprising: instruction receiving means for receiving an output instruction or an output stop instruction for a specific color portion of the received color image data; extracting means for extracting the specific color portion of the received color image data; and output stopping means for stopping the output of the specific color portion extracted by the extracting means, when the instruction receiving means receives the output stop instruction.

According to the invention, the instruction receiving means receives an output instruction or an output stop instruction for a specific color portion. The extracting means extracts the specific color portion of the received color image data. When an output stop instruction is received, the output stopping means stops the output of the specific color portion extracted by the extracting means. In the output processing of the image data containing a specific color, when an output instruction is received, an image containing both the specific color portion (important portion) and the non-specific color portion (ordinary portion) is outputted. In contrast, when an output stop instruction is received, the non-specific color portion (ordinary portion) is solely outputted with the exclusion of the specific color portion (important portion). As such, the outputting or the output stopping of the important portion (specific color portion) can be switched depending on the result of authentication. This improves the user convenience. Further, the authentication and the extraction of the specific color portion are performed in parallel. This permits efficient output processing of the image data.

In an image processing apparatus according to the invention, the storage section comprises: a semiconductor storage device for storing the specific color portion of the received image data; and a magnetic storage device for storing a non-specific color portion other than the specific color portion of the received image data.

According to the invention, the semiconductor storage device stores the specific color portion of the received image data, while the magnetic storage device stores a non-specific color portion other than the specific color portion of the received image data. The use of a magnetic storage device such as a hard disk drive permits long-term retention of the image data. Further, the specific color portion (important portion) is stored not in the magnetic storage device such as a hard disk drive, but in the semiconductor storage device such as a RAM. Thus, the important portion (specific color portion) is stored only temporarily. This improves the security.

An image processing apparatus according to the invention comprises deleting means for deleting a specific color portion which is stored in the storage section and the output processing of which is completed, once the output processing is completed.

According to the invention, once output processing is completed, the deleting means deletes a specific color portion which is stored in the storage section and the output processing of which has been completed. As such, the specific color portion the output processing of which has been completed is deleted immediately. This reduces the possibility that the important portion is illegally read out from the storage section.

An image processing apparatus according to the invention comprises encrypting means for encrypting a specific color portion to be stored into the storage section.

According to the invention, the encrypting means encrypts a specific color portion to be stored into the storage section. Since the specific color portion is stored in an encrypted state into the storage section, even in case that the specific color portion is read out from the storage section, the subject matter in the specific color portion does not leak out. This improves the security. Further, since the specific color portion is encrypted, the specific color portion may be stored in the magnetic storage device such as a hard disk drive. In this case, the entire document data including the specific color portion may be retained in the hard disk drive for a long term.

An image processing apparatus according to the invention comprises specific color reception means for receiving the specification of a specific color.

According to the invention, the specific color reception means receives the specification of a specific color, so that the outputting or the output stopping of the received specific color is controlled. The color used for the important portion is diverse depending on the user. Further, in some usage environments, an importance color (specific color) is determined in advance. Alternatively, a color that cannot be used as the importance color (specific color) is determined in advance. According to the invention, the specification of a specific color can be received, so that the specific color is variable. This permits the user to change the specific color flexibly, and hence improves the convenience.

In an image processing apparatus according to the invention, a plurality of colors are used as the specific color. In an image processing apparatus according to the invention, importance levels are set for the specific colors.

According to the invention, a plurality of colors are used as the specific color. The color used for the important portion is diverse depending on the user. Further, in some cases, a plurality of colors are used in order to clarify the difference in the importance level. This capability of setting a plurality of specific colors increases the universality (redundancy) in the colors used as specific colors, and hence improves the convenience. Further, an importance level may be set for each specific color, so that the specific color used for the output stop during the output processing of facsimile transmission, copying, or printing may be specified with the importance level.

In an image processing apparatus according to the invention, the specific color portion is a character portion in a specific color.

According to the invention, the specific color portion is a character portion in a specific color. The character portion in the specific color is not outputted. This prevents the subject matter in the important portion of the document from leaking out, and hence improves the security.

In an image processing apparatus according to the invention, the specific color portion is a graphics portion containing a specific color.

According to the invention, the specific color portion is a graphics portion containing a specific color. In case that a specific color portion is a part of graphics, even when the specific color portion is deleted (for example, converted into white), the deleted specific color portion can easily be inferred in some cases depending on the contents of the drawing. Thus, even when only a part of a drawing contains the specific color, the entire outputting of the drawing is stopped. This prevents the important graphics to be outputted, and hence improves the security.

In an image processing apparatus according to the invention, the output stopping means replaces a specific color portion with a predetermined mark.

According to the invention, the output stopping means replaces a specific color portion with a predetermined mark, so as to stop the output of the specific color portion. For example, the specific color portion may be replaced with an underline or a painted-out mark. In the case that the outputting of the specific color portion is stopped and the non-specific color portion is outputted solely, the user may misunderstand as if the document were prepared inappropriately, or alternatively as if a fault occurred in the equipment. Thus, when the specific color portion is indicated by a predetermined mark such as an underline, the user can understand that the non-printing is intentional.

An image processing apparatus according to the invention comprises notifying means for notifying the output stop of a specific color portion, when the outputting of the specific color portion is stopped.

According to the invention, when the outputting of a specific color portion is stopped, the notifying means notifies the output stop of the specific color portion. For example, a message may be displayed on an operation panel. In the case that the outputting of the specific color portion is stopped and the non-specific color portion is outputted solely, the user may misunderstand as if the document were prepared inappropriately, or alternatively as if a fault occurred in the equipment. Thus, when the non-output of the specific color portion is notified, the user can understand that the non-printing is intentional.

An aspect of the invention is an image processing apparatus for receiving color image data so as to store the data into a storage section and then performing output processing including the transmission of the color image data stored in the storage section, the apparatus comprising: destination storing means for storing a destination to which the transmission of a specific color portion of the received color image data is allowed; extracting means for extracting the specific color portion of the received color image data, when the destination of the received color image data is not stored in the destination storing means; and output stopping means for stopping the output of the specific color portion extracted by the extracting means.

According to the invention, the destination storing means stores a destination to which the transmission of a specific color portion is allowed. When the destination of received color image data is not stored (not registered) in the destination storing means, extracting means extracts the specific color portion of the received color image data, so that the output stopping means stops the output of the extracted specific color portion. Thus, in transmission to a destination not registered in advance, the specific color portion is not outputted. Accordingly, even in case that an incorrect facsimile number is inputted, the important portion is not transmitted to the incorrect destination.

An aspect of the invention is an image processing apparatus for receiving color image data so as to store the data into a storage section and then performing output processing including the transmission of the color image data stored in the storage section, the apparatus comprising: destination storing means for storing a destination to which the transmission of a specific color portion of the received color image data is allowed; extracting means for extracting the specific color portion of the received color image data; and output stopping means for stopping the output of the specific color portion extracted by the extracting means, when the destination of the received color image data is not stored in the destination storing means.

According to the invention, the destination storing means stores a destination to which the transmission of a specific color portion is allowed. The extracting means extracts the specific color portion of the received color image data. When the destination of the received color image data is not stored (not registered) in the destination storing means, the output stopping means stops the output of the specific color portion extracted by the extracting means. Thus, in transmission to a destination not registered in advance, the specific color portion is not outputted. Accordingly, even in case that an incorrect facsimile number is inputted, the important portion is not transmitted to the incorrect destination. Further, the determination of whether the destination is stored in the destination storing means or not and the extraction of the specific color portion are performed in parallel. This permits efficient output processing of the image data.

In an image processing apparatus according to the invention, output processing includes the transmission of image data, while the apparatus comprises encrypting means for encrypting a specific color portion of the image data to be transmitted.

According to the invention, output processing includes the transmission of image data, while the encrypting means encrypts a specific color portion to be transmitted. The encryption scheme and the key are determined in advance. Then, the encrypted image data is decrypted by the destination. In the transmission of image data by facsimile or the like, since the specific color portion (important portion) is encrypted, even when the transmitted data is intercepted and read out illegally, the subject matter of the important portion does not leak out.

An aspect of the invention is an image processing apparatus comprising transmitting means for transmitting specific color information concerning a specific color. Another aspect of the invention is an information processing apparatus for transmitting image data to the image processing apparatus, the information processing apparatus comprising: reception means for receiving specific color information concerning a specific color; and converting means for converting into the specific color a predetermined color in the image data to be transmitted to the image processing apparatus.

In the image processing apparatus according to the invention, the transmitting means transmits specific color information concerning a specific color. In the information processing apparatus such as a computer for transmitting image data to the image processing apparatus, the reception means receives specific color information concerning a specific color, while the converting means converts into the specific color a predetermined color in the image data to be transmitted to the image processing apparatus. Since the specific color information concerning the specific color is transmitted from the image processing apparatus to the information processing apparatus (computer), the information processing apparatus (computer) can convert the predetermined color into the specific color before the transmission to the image processing apparatus. The color used for the important portion is diverse depending on the user. However, the information processing apparatus (computer) can convert the importance color (predetermined color) used individually by each user into the specific color specified by the image processing apparatus. This permits the user to change flexibly the color (importance color) used for the important portion, and hence improves the convenience.

According to the invention, the information processing apparatus (computer) for transmitting image data to the image processing apparatus encrypts the image data to be transmitted to the image processing apparatus. The encryption scheme and the key are determined in advance. Then, the encrypted image data is decrypted by the image processing apparatus. Since the specific color portion (important portion) in a confidential document is encrypted before the transmission to the image processing apparatus, the subject matter of the important portion is prevented from leaking out.

According to the invention, the information processing apparatus (computer) for transmitting image data to the image processing apparatus receives specific color information concerning a specific color from the image processing apparatus, so as to converts into a deletion color a specific color portion in the image data to be transmitted to the image processing apparatus. For example, when the printout is to be performed on white paper, the specific color is converted into white (deletion color). Alternatively, the specific color may be converted into a predetermined mark such as an underline and a painted-out mark. Since the specific color information concerning the specific color is transmitted from the image processing apparatus to the information processing apparatus (computer), the information processing apparatus (computer) can convert the specific color into a deletion color (or a predetermined mark) before the transmission to the image processing apparatus. Since the information processing apparatus (computer) converts the specific color into a deletion color (or a predetermined mark), the output stop processing of the specific color becomes unnecessary in the image processing apparatus. This reduces the load of output processing.

According to the invention, the information processing apparatus (computer) for transmitting image data to the image processing apparatus acquires specific color information concerning a specific color from the image processing apparatus, so as to converts into a non-specific color the specific color in the image data to be transmitted to the image processing apparatus. Even when the output of the specific color is inhibited in the image processing apparatus, the computer can convert the specific color into the non-specific color, so that the specific color portion can be printed out. In many of such cases, the person who prints out the confidential document is the user (the author of the confidential document) oneself who has prepared the confidential document with the information processing apparatus (computer). Thus, there is merely a little possibility that the confidential document leaks out. As such, the convenience during printout is improved for the user preparing a confidential document.

According to the invention, the information processing apparatus (computer) for transmitting image data to the image processing apparatus receives an output instruction or an output stop instruction for a specific color portion, and then transmits the output instruction or the output stop instruction having been received to the image processing apparatus. For example, the information processing apparatus can receive an output instruction or an output stop instruction for the specific color portion through a keyboard, so as to instruct the image processing apparatus to perform the outputting or the output stopping of the specific color. Since the outputting of the specific color portion can be instructed at the time of printout, the convenience during printout is improved for the user preparing a confidential document.

An aspect of the invention is an image processing method which uses an image processing apparatus for receiving color image data so as to store the data into a storage section and then performing the output processing of the color image data stored in the storage section or alternatively the output processing with the exclusion of a specific color, the method comprising the steps of: acquiring specific color information concerning the specific color of the received color image data; authenticating the requestor of the output processing of the color image data the specific color information of which is acquired; and extracting a specific color portion of the received color image data, when the authentication is failed; wherein the outputting of the extracted specific color portion is stopped.

An aspect of the invention is an image processing apparatus for receiving color image data so as to store the data into a storage section and then performing the output processing of the color image data stored in the storage section or alternatively the output processing with the exclusion of a specific color, the apparatus comprising: acquiring means for acquiring specific color information concerning the specific color of the received color image data; authenticating means for authenticating the requestor of the output processing of the color image data the specific color information of which is acquired by the acquiring means; extracting means for extracting a specific color portion of the received color image data, when the authentication is failed in the authenticating means; and output stopping means for stopping the output of the specific color portion extracted by the extracting means.

According to the invention, specific color information concerning the specific color of received color image data is acquired, while the requestor of the output processing of the color image data the specific color information of which is acquired is authenticated. When the authentication is failed, a specific color portion of the received color image data is extracted, so that the outputting of the extracted specific color portion is stopped. The image data can be received by reading the color image of an original document through a color scanner, or by receiving color image data from a computer. The received image data can be printed out on recording paper or transmitted by facsimile. When the authentication is successful, image data including the specific color portion is outputted, whereas when the authentication is failed, image data without the specific color portion is outputted.

An aspect of the invention is an image processing method which uses an image processing apparatus for receiving color image data so as to store the data into a storage section and then performing the output processing of the color image data stored in the storage section or alternatively the output processing with the exclusion of a specific color, the method comprising the steps of: acquiring specific color information concerning the specific color of the received color image data; authenticating the requestor of the output processing of the color image data the specific color information of which is acquired; and extracting a specific color portion of the received color image data; wherein when the authentication is failed, the outputting of the extracted specific color portion is stopped.

An aspect of the invention is an image processing apparatus for receiving color image data so as to store the data into a storage section and then performing the output processing of the color image data stored in the storage section or alternatively the output processing with the exclusion of a specific color, the apparatus comprising: acquiring means for acquiring specific color information concerning the specific color of the received color image data; authenticating means for authenticating the requestor of the output processing of the color image data the specific color information of which is acquired by the acquiring means; extracting means for extracting a specific color portion of the received color image data; and output stopping means for stopping the output of the specific color portion extracted by the extracting means, when the authentication is failed in the authenticating means.

According to the invention, specific color information concerning the specific color of received color image data is acquired, while a specific color portion of the received color image data the specific color information of which is acquired is extracted. Further, the requestor of the output processing of the color image data the specific color information of which is acquired is authenticated. When the authentication is failed, the outputting of the extracted specific color portion is stopped. When the authentication is successful, image data including the specific color portion is outputted, whereas when the authentication is failed, image data without the specific color portion is outputted. Further, the authentication and the extraction of the specific color portion are performed in parallel. This permits efficient output processing of the image data.

An aspect of the invention is an image processing apparatus for receiving color image data so as to store the data into a storage section and then performing output processing including the transmission of the color image data stored in the storage section or alternatively the transmission with the exclusion of a specific color, the apparatus comprising: acquiring means for acquiring specific color information concerning the specific color of the received color image data; destination storing means for storing a destination to which the transmission of the specific color portion of the received color image data is allowed; determining means for determining whether the destination of the color image data the specific color information of which is acquired by the acquiring means is stored in the destination storing means or not; extracting means for extracting the specific color portion of the received color image data, when the determining means determines that the destination of the color image data is not stored in the destination storing means; and output stopping means for stopping the output of the specific color portion extracted by the extracting means.

According to the invention, the acquiring means acquires specific color information concerning the specific color of received color image data. The destination storing means stores a destination to which the transmission of the specific color portion of the received color image data is allowed. The determining means determines whether the destination of the color image data the specific color information of which is acquired is stored (registered) in the destination storing means or not. When it is determined that the destination of the color image data is not stored in the destination storing means, the extracting means extracts the specific color portion of the received color image data, so that the outputting of the extracted specific color portion is stopped. Thus, image data including the specific color portion is transmitted to the destination stored in the destination storing means, whereas image data without the specific color portion is transmitted to the destination not stored in the destination storing means.

An aspect of the invention is an image processing apparatus for receiving color image data so as to store the data into a storage section and then performing output processing including the transmission of the color image data stored in the storage section or alternatively the transmission with the exclusion of a specific color, the apparatus comprising: acquiring means for acquiring specific color information concerning the specific color of the received color image data; destination storing means for storing a destination to which the transmission of the specific color portion of the received color image data is allowed; determining means for determining whether the destination of the color image data the specific color information of which is acquired by the acquiring means is stored in the destination storing means or not; extracting means for extracting the specific color portion of the received color image data; and output stopping means for stopping the output of the specific color portion extracted by the extracting means, when the determining means determines that the destination of the color image data is not stored in the destination storing means.

According to the invention, the acquiring means acquires specific color information concerning the specific color of received color image data, while the extracting means extracts a specific color portion of the received color image data the specific color information of which is acquired. Further, the destination storing means stores a destination to which the transmission of the specific color portion of the received color image data is allowed. The determining means determines whether the destination of the color image data the specific color information of which is acquired is stored (registered) in the destination storing means or not. When it is determined that the destination of the color image data is not stored in the destination storing means, the outputting of the extracted specific color portion is stopped. Thus, image data including the specific color portion is transmitted to the destination stored in the destination storing means, whereas image data without the specific color portion is transmitted to the destination not stored in the destination storing means. Further, the determination of whether the destination is stored in the destination storing means or not and the extraction of the specific color portion are performed in parallel. This permits efficient output processing of the image data.

In an image processing apparatus according to the invention, specific color information is added to received image data, while the acquiring means extracts the specific color information added to the received image data.

According to the invention, specific color information is added to received image data, while the acquiring means extracts the specific color information added to the received image data. For example, the specific color information in the form of a bar code or the like according to a predetermined rule is added to the image data. The acquiring means recognizes the bar code through an OCR or the like, so as to acquire the specific color information corresponding to the bar code.

In an image processing apparatus according to the invention, a plurality of colors are used as the specific color.

According to the invention, a plurality of colors are used as the specific color. The color used for the important portion (confidential portion) is diverse depending on the user. Further, in some cases, a plurality of colors are used in order to clarify the difference in the importance level. By virtue of this capability of setting a plurality of specific colors in the specific color information, a document can be prepared using a plurality of specific colors.

In an image processing apparatus according to the invention, importance levels are set for the specific colors.

According to the invention, a plurality of colors are used as the specific color, while an importance level is set for each specific color. For example, an importance level (confidentiality level) may be set for each of a plurality of specific colors in document data to be output-processed, so that the outputting of each specific color may be stopped depending on the importance level during the output processing. Alternatively, an importance level may be set for an underlined portion, so that the underlined portion may be converted into a specific color depending on the importance level.

An aspect of the invention is an information processing apparatus for transmitting image data to an image processing apparatus according to the invention, wherein the information processing apparatus comprises reception means for receiving specific color information concerning a specific color of the image data to be transmitted, and wherein the information processing apparatus transmits: the image data; and the specific color information received by the reception means.

According to the invention, specific color information concerning a specific color of the image data to be transmitted from the information processing apparatus is received, so that the image data and the received specific color information are transmitted to the image processing apparatus according to the invention. Depending on the result of authentication or the like, the image processing apparatus outputs the specific color portion of the image data, or alternatively stops the output thereof. This allows the user to instruct to the image processing apparatus the specific color of the image data to be transmitted.

An aspect of the invention is an information processing apparatus, comprising adding means for adding the specific color information received by the reception means to the image data to be transmitted, wherein the information processing apparatus transmits the image data to which the specific color information has been added by the adding means.

According to the invention, the adding means adds the specific color information received by the information processing apparatus to the image data to be transmitted, so that the image data to which the specific color information has been added is transmitted to the image processing apparatus. For example, the specific color information in the form of a bar code or the like according to a predetermined rule is added to the image data. By virtue of this, the user can specify the specific color of the image data to be transmitted, so that the image data to which the specific color information concerning the specified specific color has been added can be transmitted to the image processing apparatus.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing the configuration of an image processing apparatus according to the invention;

FIG. 2 is a block diagram showing a communication network to which an image processing apparatus is connected;

FIG. 3 is a diagram showing detailed configuration of a portion relating mainly to image read and image formation in an image processing apparatus;

FIG. 4 is a diagram showing outlined configuration of an image forming section;

FIG. 5A is a diagram showing an example of original document;

FIGS. 5B and 5C are diagrams each showing an example of printed-out recording paper;

FIG. 6 is a block diagram showing the configuration of another image processing apparatus according to the invention;

FIG. 7 is a block diagram showing the configuration of another image processing apparatus according to the invention;

FIG. 8 is a block diagram showing the configuration of an image processing apparatus for storing image data (both a specific color portion and a non-specific color portion) into a RAM;

FIGS. 9A and 9B are diagrams each showing an example of printed-out recording paper;

FIG. 10 is a flowchart showing the procedure of separating a specific color when the specific color is contained in graphics;

FIG. 11 is a block diagram showing an example of image processing apparatus for stopping the output of a specific color portion depending on the destination;

FIG. 12 is a diagram showing an example of specific color information in which confidentiality levels are set;

FIG. 13 is a block diagram showing an example of configuration of a computer (information processing apparatus) connected to an image processing apparatus according to the invention;

FIG. 14 is a diagram showing an example of printout of document data;

FIG. 15 is a block diagram showing an example of configuration of a computer connected to an image processing apparatus according to the invention;

FIG. 16 is a flowchart showing the procedure of color conversion;

FIG. 17 is a color map diagram showing schematically the distribution of the colors used by a computer;

FIG. 18 is a block diagram showing the configuration of another image processing apparatus according to the invention;

FIG. 19A is a diagram showing an example of original document;

FIGS. 19B and 19C are diagrams each showing an example of printed-out recording paper;

FIG. 20 is a block diagram showing the configuration of another image processing apparatus according to the invention;

FIG. 21 is a block diagram showing the configuration of an image processing apparatus for storing image data (both a specific color portion and a non-specific color portion) into a RAM;

FIG. 22 is a block diagram showing an example of image processing apparatus for stopping the output of a specific color portion depending on the destination;

FIG. 23 is a block diagram showing an example of configuration of a computer connected to an image processing apparatus according to the invention;

FIG. 24 is a diagram showing an example of printout of document data;

FIG. 25 is a diagram showing an example of importance color information in which importance levels are set;

FIG. 26 is a block diagram showing an example of configuration of a computer connected to an image processing apparatus according to the invention;

FIG. 27 is a color map diagram showing schematically the distribution of the colors used by a computer;

FIG. 28 is a flowchart showing an example of procedure of adding specific color information;

FIG. 29 is a flowchart showing an example of procedure of checking the color of an important portion;

FIG. 30 is a flowchart showing an example of procedure of converting the color in document data; and

FIG. 31 is a flowchart showing an example of procedure of image formation in an image processing apparatus.

### DETAILED DESCRIPTION OF THE INVENTION

The invention is described below in detail with reference to the drawings illustrating the embodiments thereof. It should be noted that the invention is not restricted to the following embodiments.

### Embodiment 1

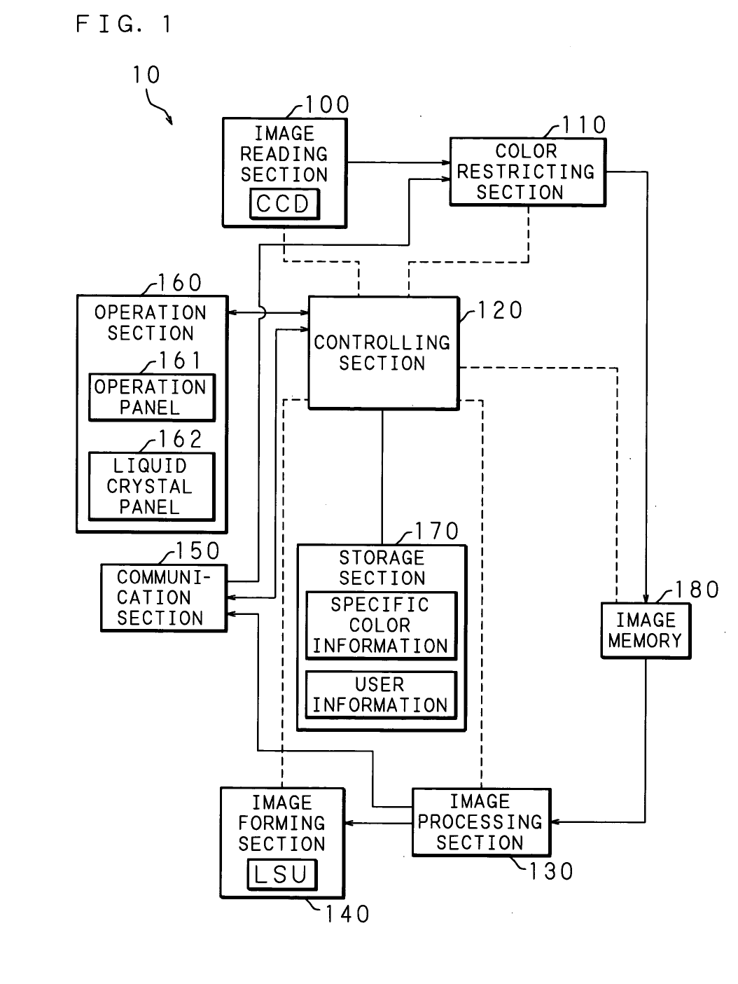

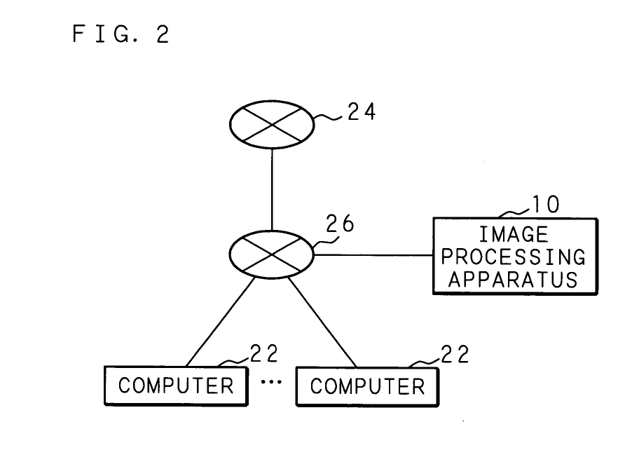

FIG. 1 is a block diagram showing the configuration of an image processing apparatus 10 according to the invention. FIG. 2 is a block diagram showing a communication network to which the image processing apparatus 10 is connected. The image processing apparatus 10 comprises: an image reading section 100; a communication section 150; a color restricting section 110 connected to the image reading section 100 and the communication section 150; an image memory 180 connected to the color restricting section 110; an image processing section 130 connected to the image memory 180 and the communication section 150; an image forming section 140 connected to the image processing section 130; a controlling section 120 connected to these sections so as to control these sections; and a storage section 170 and an operation section 160 each connected to the controlling section 120.

The operation section 160 comprises, for example, an operation panel 161 and a liquid crystal panel 162. The controlling section 120 receives an operation instruction from the operation panel 161, and displays processing status onto the liquid crystal panel 162. As shown in FIG. 2, the image processing apparatus 10 (communication section 150) is connected to a network 26 to which computers 22 are connected. The network 26 is connected to an external network 24 such as the Internet and a telephone line. When receiving an operation instruction from the operation section 160 (operation panel 161) or the communication section 150 (computer 22), the controlling section 120 performs output processing such as printout (copying and printing) and facsimile transmission. The output processing includes image data transmission and email transmission to the computer 22, in addition to the printout and the facsimile transmission.

The image reading section 100 is a device (such as a color scanner) for reading and converting an original color document into a plurality of color components so as to output the generated image data. In the image forming section 140, light exposure means forms an electrostatic latent image corresponding to the received image data onto an image carrying medium. The electrostatic latent image is visualized using a developer agent, so that the visualized image is transferred onto a recording medium (recording paper).

The image reading section 100 comprises a CCD (charged coupled device) or the like, and reads the image data of a document so as to transmit the read-out image data to the color restricting section 110. The communication section 150 controls the communication with the network 26. For example, the communication section 150 receives image data from the computer 22, and transmits the received image data to the color restricting section 110.

The storage section 170 stores: specific color information concerning a specific color; and user information concerning a user who is allowed to execute the output of a specific color portion of image data. The controlling section 120 serves as means (an authenticating section) for authenticating the output requestor of the image data received by the image reading section 100 or the communication section 150. When the authentication is not completed, the controlling section 120 issues an output stop instruction for the specific color portion, to the color restricting section 110.

When receiving an output stop instruction (including specific color information) for a specific color portion from the controlling section 120, the color restricting section 110 serves as means (an extracting section) for extracting the specific color portion of the image data received from the image reading section 100 or the communication section 150 and as means (an output stopping section) for stopping the output of the extracted specific color portion. For example, when the printout is performed onto white paper, the color restricting section 110 may convert the specific color into a deletion color (white), or alternatively may paint out the specific color portion with white or the like. The image data the specific color portion of which has been deleted (converted into white) is transmitted from the color restricting section 110 to the image memory (storage section) 180. When no output stop instruction is issued from the controlling section 120, the color restricting section 110 transfers the received image data intact to the image memory 180.

In response to an instruction, for example, from the operation section 160, the image processing section 130 performs image processing such as the enlargement and the contraction of the image data read out from the image memory 180. Further, in response to an instruction from the controlling section 120, the image processing section 130 transmits the image data to the image forming section 140 or the communication section 150. The image forming section 140 comprises an LSU (laser scanning unit) or the like and, for example, forms an electrostatic latent image corresponding to the image data received from the image processing section 130 onto a photosensitive body, so as to form (print out) an image onto recording paper. The communication section 150 transmits the image data received from the image processing section 130 to a destination (the computer 22 or an external facsimile machine) specified by the controlling section 120.

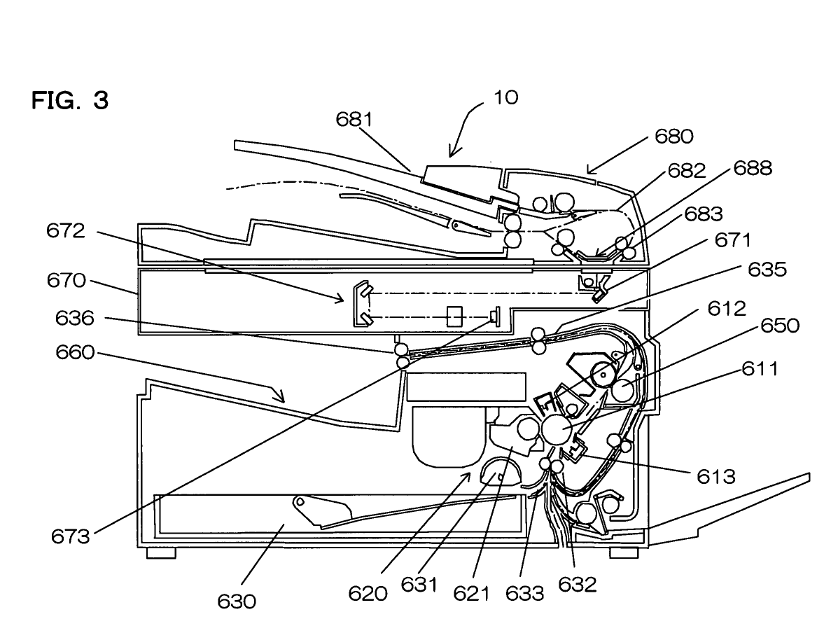

FIG. 3 shows detailed configuration of a portion relating mainly to image read and image formation (printout) in the image processing apparatus 10. The image processing apparatus 10 comprises an original document table 670 provided with a transparent glass plate or the like on top thereof. An optical system for reading an original document is arranged under the original document table 670. The optical system comprises: an exposure light source 671 for irradiating with light the original document placed on the original document table 670; an imaging lens; and a plurality of mirrors 672 for guiding light to a photoelectric conversion device (CCD) 673.

An automatic original document feeder 680 for feeding the original document sheets automatically so as to assist the read of the original document is arranged on the original document table 670. When original document sheets are set in a feeder tray 681, the automatic original document feeder 680 feeds the original document sheets one by one to a feeder path 682. The original document sheet having been fed in stops temporarily in a state that the front edge thereof abuts against a PS roller 683. When a clutch not shown is turned ON, the PS roller 683 is linked with a drive section of a feeder motor not shown, so that the temporarily stopped feeding of the original document sheet is restarted. Thus, the original document sheet is fed to an original document reading window 688.

The exposure light source 671 is moved to a position immediately under the original document reading window 688. The original document sheet is irradiated with light in synchronization with the start of feeding of the original document sheet. The reflected light from the original document sheet is lead to the CCD 673 via the various components of the optical system. The original document image data read out by the CCD 673 undergoes image processing in the image processing section 130 and the like shown in FIG. 1. Then, the laser scanning unit (LSU) 621 irradiates with laser light the surface of the image carrying medium (photosensitive body) 611, so as to form an electrostatic latent image.

The photosensitive body 611 has a drum shape, and is driven and revolved. Arranged around the photosensitive body 611 is a developer unit 620 for developing with toner the electrostatic latent image formed in the photosensitive body 611 surface, so as to form a visible image. Also arranged around the photosensitive body 611 are: a transfer charger 613 for transferring the toner image from the photosensitive body 611 surface onto a paper sheet; a cleaner unit for removing the remnant toner on the photosensitive body 611 surface; a charger 612 for charging the photosensitive body 611 surface at a predetermined electric potential; and the LSU 621 for projecting laser light onto a laser light projection point on the photosensitive body 611.

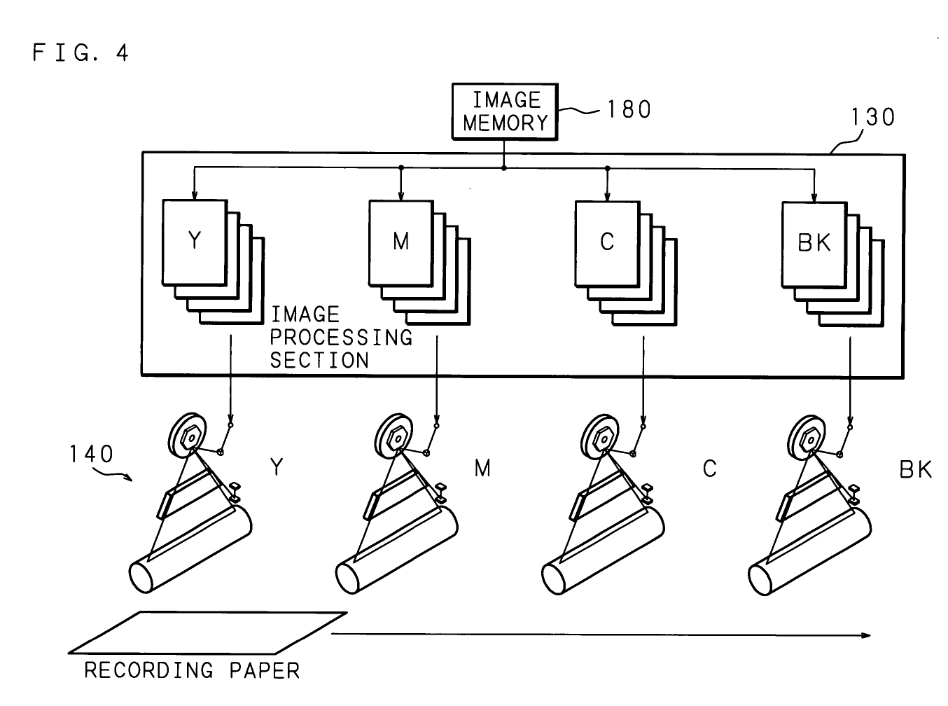

The image processing apparatus 10 according to the present embodiment can treat the read and the output (printout) of a color image. FIG. 4 is a diagram showing outlined configuration of the image forming section 140. The image data stored in the image memory 180 is transmitted to the image processing section 130, and then converted into page-basis output images by the image processing section 130. The images are then color-decomposed on a page basis. The color decomposition is performed, for example, into Y (yellow), M (magenta), C (cyan), and BK (black). Each piece of the color-decomposed image data is transmitted to the image forming section 140. The image forming section 140 forms an electrostatic latent image of each color into the photosensitive body for the color. The image of each color is transferred onto recording paper, so as to generate a color image.

Recording paper sheets are stored in a paper sheet cassette 630 shown in FIG. 3. A semicircular roller 631 for feeding the recording paper sheet into a feed path 633 is arranged in the front portion of the paper sheet cassette 630. Arranged along the feed path from the feeder side to the ejection side of the recording paper sheet are: a pre-resist detection switch (not shown) for detecting the passing of the paper sheet; a PS roller 632 for positioning the toner image on the photosensitive body 611 relative to the paper sheet on the basis of the signal of the pre-resist detection switch; a fixer roller section 650 for fixing the toner image on the paper sheet by means of a heating roller and a pressurizing roller; a fixed paper sheet detection switch (not shown) for detecting the passing of the paper sheet through the fixer roller section 650; a paper sheet ejection detection switch (not shown) for detecting the passing of the paper sheet through an ejection path 635; and a paper sheet ejection roller 636 for ejecting the recording paper sheet. The recording paper sheet is fed from the paper sheet cassette 630, then passes through the above-mentioned sections, and then is ejected into an ejected paper sheet tray 660. As such, a series of output processing (printout) is completed.

In the image processing apparatus 10, for example, when the image reading section 100 reads an original color document in which a confidential portion is prepared in a specific color, the controlling section 120 controls the operation such that authentication information such as a password is received from the operation section 160. The controlling section 120 compares the received authentication information with the user information stored in the storage section 170, so as to perform authentication. When the authentication is not completed, the controlling section 120 issues an output stop instruction for the specific color to the color restricting section 110. The color restricting section 110 then deletes the specific color portion (extracts the specific color portion and then converts the extracted specific color portion into white or the like) of the image data received from the image reading section 100 or the communication section 150. Then, the image data the specific color portion of which has been deleted is transmitted to the image memory 180. When the authentication is completed, the controlling section 120 does not issue an output stop instruction for the specific color to the color restricting section 110. The color restricting section 110 transmits intactly the image data received from the image reading section 100 or the communication section 150, to the image memory 180. The image data transmitted to the image memory 180 is further transmitted through the image processing section 130 to the image forming section 140 and then printed out onto recording paper, or alternatively is transmitted through the image processing section 130 to the communication section 150 and then transmitted by facsimile.

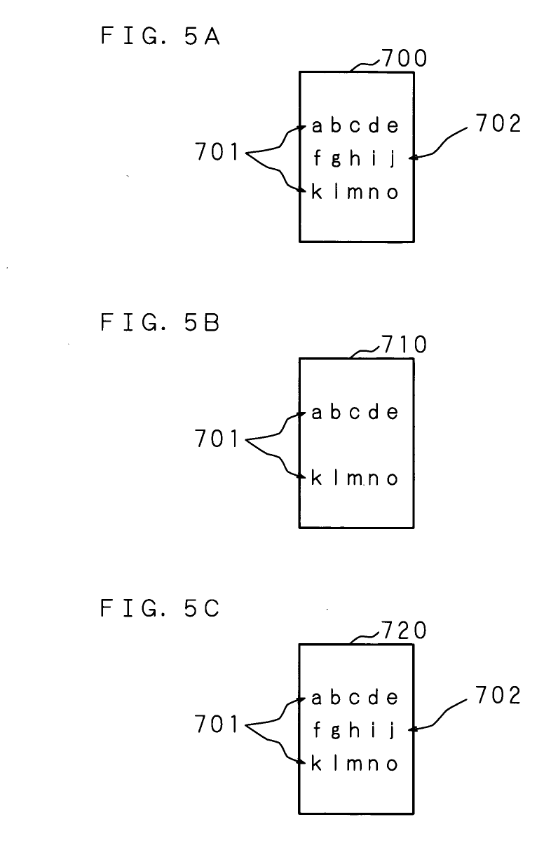

FIG. 5A is a diagram showing an example of original document. FIGS. 5B and 5C are diagrams each showing an example of printed-out recording paper. The original document 700 of FIG. 5A comprises: a specific color portion 702 prepared in red or the like; and a non-specific color portion 701 prepared in black. As described above, when the authentication is not completed, the controlling section 120 controls the color restricting section 110 to delete (convert into white) the specific color portion. As a result, as shown in FIG. 5B, the non-specific color portion 701 is recorded (outputted) on the recording paper 710, whereas the specific color portion 702 is not recorded (the outputting is stopped). When the authentication is completed, as described above, the controlling section 120 controls the color restricting section 110 to transmit the image data intactly. As a result, as shown in FIG. 5C, both the specific color portion 702 and the non-specific color portion 701 are recorded on the recording paper 720.

The present embodiment has been described for the case that the data is printed out on recording paper. However, the image data transmitted to the image memory 180 may be further transmitted through the image processing section 130 to the communication section 150, so as to be transmitted by facsimile. Alternatively, the image data received from the computer 22 by the communication section 150 may be printed out by the image forming section 140, or alternatively may be transmitted by facsimile from the communication section 150.

In addition to the authentication scheme that the operation section 160 or the communication section 150 receives a password, the authentication may be performed by another scheme that an acquiring section provided in the image processing apparatus 10 acquires authentication information in a radio frequency tag or an IC card, so as to transmit the authentication information to the controlling section 120. Other various authentication schemes may also be used such as a scheme that the communication section 150 receives the IP address of the computer 22 so as to use the IP address in the authentication.

In addition to the method that the color image read out by the image reading section 100 is outputted intactly in color, the output (printout) of the image data containing the specific color portion may be performed by a method that the color image read out by the image reading section 100 is printed out or transmitted in black and white, for example, in case that the image forming section 140 can process only black and white printing, or alternatively in case of facsimile transmission.

In the above-mentioned embodiment, the outputting or the output stopping of the specific color portion has been performed depending on the completion or non-completion of the user authentication. However, the user may specify the outputting or the output stopping of the specific color portion. In this case, for example, the operation section 160 or the communication section 150 may serve as means (an instruction receiving section) for receiving an output instruction or an output stop instruction for the specific color portion. Further, the color restricting section 110 may serve as means (an extracting section) for extracting the specific color portion on the basis of the output instruction or the output stop instruction from the controlling section 120, and as means (an output stopping section) for stopping the output of the extracted specific color portion (for example, converting the specific color portion into white).

For example, the controlling section 120 or the storage section 170 may be set such as to stop the output of the specific color portion in a default condition. Then, the user may issues an output instruction for the specific color through the operation section 160 or the communication section 150 (computer 22) when necessary. In this case, in an ordinary condition, the controlling section 120 issues an output stop instruction for the specific color portion to the color restricting section 110. However, when receiving an output instruction for the specific color, the controlling section 120 does not issue an output stop instruction for the specific color portion. Alternatively, the output of the specific color portion may be performed in a default condition. In this case, when the user issues an output stop instruction for the specific color portion, the color restricting section 110 may delete (for example, convert into white) the specific color portion. As such, the outputting or the output stopping of the specific color portion may be performed depending on the output instruction or the output stop instruction issued by the user. Further, the deletion of the specific color portion (the extraction of the specific color portion and the conversion of the extracted specific color portion into white or the like) may be performed by the controlling section 120 or the image processing section 130.

In response to a change instruction for the specific color received by the operation section 160 or the communication section 150 (specific color reception section), the controlling section 120 can update the specific color information stored in the storage section 170. For example, since red is used generally and frequently in an emphasized portion (not a confidential portion), blue may be set as the specific color. However, the update of the specific color information is performed preferably only after the completion of authentication based on the user information.

Such a case that the image processing apparatus 10 prints out image data containing a specific color portion received from the computer 22 occurs often when a user preparing a confidential document containing a specific color portion by using the computer 22 is printing out the document for the check of the contents. Thus, for user convenience, the user information or the operation of the controlling section 120 may be set such that the image data received from the computer 22 by the communication section 150 is printed out intactly.

Since the copying or the printing of a confidential portion prepared in a specific color is restricted, the security is improved. The copying or the printing of the specific color portion can be performed on the basis of authentication or instruction. This improves the user convenience, with maintaining a high security level. Further, since the confidentiality is ensured by preparing the confidential portion in the specific color, a document containing a confidential portion can be prepared easily and efficiently.

### Embodiment 2

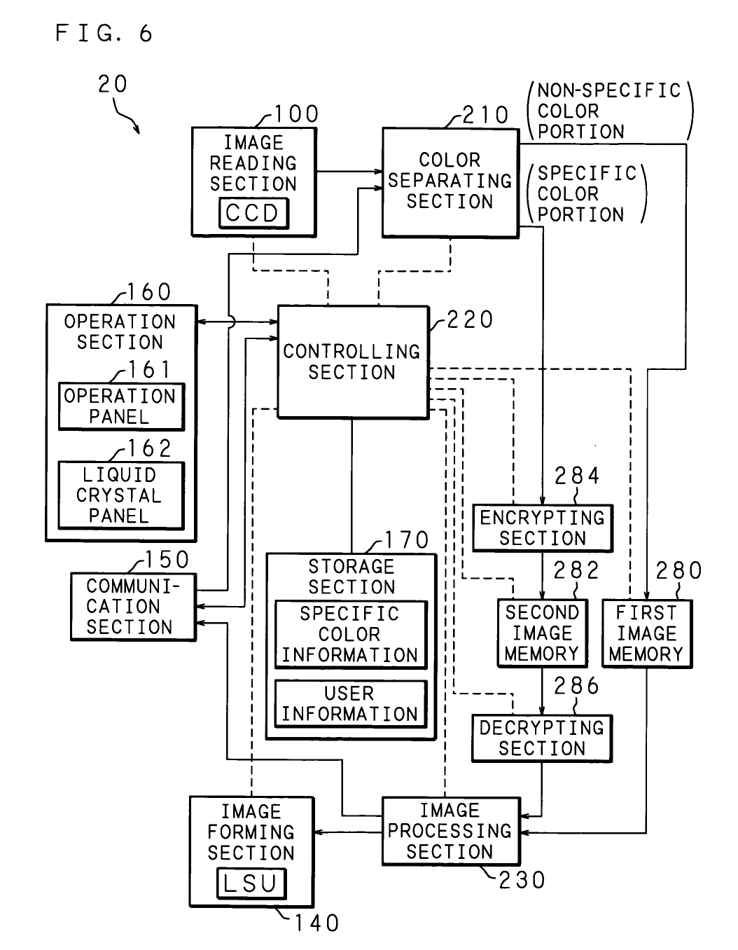

FIG. 6 is a block diagram showing the configuration of another image processing apparatus 20 according to the invention. The image processing apparatus 20 comprises: an image reading section 100; a controlling section 220; an image processing section 230; an image forming section 140; a communication section 150; an operation section 160; and a storage section 170. The image processing apparatus 20 further comprises: a color separating section 210 connected to the image reading section 100 and the communication section 150; an encrypting section 284 connected to the color separating section 210; a second image memory 282 connected to the encrypting section 284; and a decrypting section 286 connected between the second image memory 282 and the image processing section 230. Further, a first image memory 280 is connected between the color separating section 210 and the image processing section 230. These sections are controlled by the controlling section 220. The encrypting section 284 may be integrated with the color separating section 210. The decrypting section 286 may be integrated with the image processing section 230.

The color separating section (extracting section) 210 extracts a specific color portion of image data received from the image reading section 100 or the communication section 150, so as to separate the data into the specific color portion and the non-specific color portion. The separated specific color portion is transmitted to the encrypting section 284, while the non-specific color portion is transmitted to the first image memory 280. The encrypting section 284 encrypts the specific color portion received from the color separating section 210, and then transmits the encrypted specific color portion to the second image memory 282.

The decrypting section 286 decrypts the encrypted specific color portion stored in the second image memory 282, and then transmits the decrypted specific color portion to the image processing section 230. The image processing section (output stopping section) 230 receives the non-specific color portion stored in the first image memory 280 and the specific color portion decrypted by the decrypting section 286. When an output stop instruction for the specific color is issued from the controlling section 220, the image processing section 230 transmits solely the non-specific color portion to the image forming section 140 or the communication section 150. When no output stop instruction for the specific color is issued from the controlling section 220, the image processing section 230 combines the specific color portion and the non-specific color portion into original image data in the form not-yet separated by the color separating section 210, and then transmits the data to the image forming section 140 or the communication section 150.

In Embodiment 2, the first image memory 280 and the second image memory 282 are separate to each other. However, the first image memory 280 and the second image memory 282 may be integrated into an identical image memory. In this case, the storage region is separated into a first storage region and a second storage region, so that the first storage region stores the non-specific color portion, while the second storage region stores the encrypted specific color portion. Further, encryption and decryption may be performed in the controlling section 220.

Since the specific color portion is encrypted and stored in an image memory (second image memory 282), even in case that the contents of the image memory is read out, the subject matter of the encrypted confidential portion (specific color portion) does not leak out. Further, when receiving an output stop instruction from the controlling section 220, the color separating section (extracting section and output stopping section) 210 may stop the transfer of the specific color portion to the encrypting section 284. In this case, during the output stop, the confidential portion (specific color portion) is not stored in the second image memory 282. This prevents more securely the confidential portion from leaking out.

### Embodiment 3

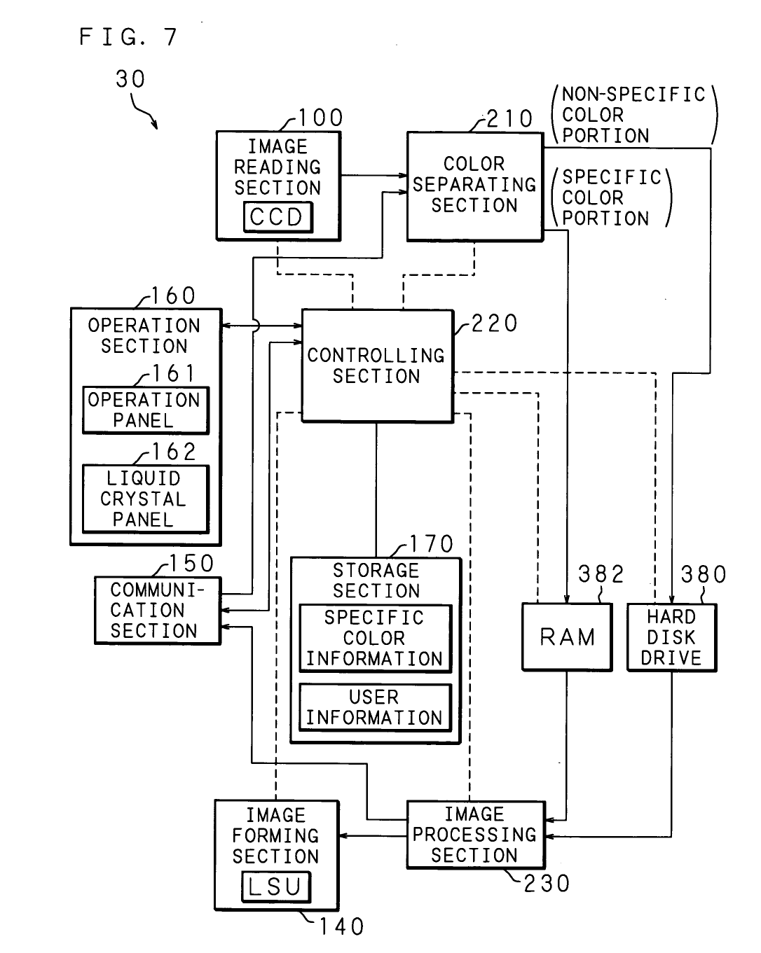

FIG. 7 is a block diagram showing the configuration of another image processing apparatus 30 according to the invention. The image processing apparatus 30 comprises: an image reading section 100; a color separating section 210; a controlling section 220; an image processing section 230; an image forming section 140; a communication section 150; an operation section 160; and a storage section 170; which are similar to these of Embodiment 2. The image processing apparatus 30 further comprises a RAM (semiconductor storage device) 382 and a hard disk drive (magnetic storage device) 380 each connected between the color separating section 210 and the image processing section 230.

The color separating section (extracting section) 210 extracts a specific color portion of image data received from the image reading section 100 or the communication section 150, so as to separate the data into the specific color portion and the non-specific color portion. The separated specific color portion is transmitted to the RAM 382, while the non-specific color portion is transmitted to the hard disk drive 380. The image processing section (output stopping section) 230 receives the specific color portion stored in the RAM 382 and the non-specific color portion stored in the hard disk drive 380. When an output stop instruction for the specific color is issued from the controlling section 220, the image processing section 230 transmits solely the non-specific color portion to the image forming section 140 or the communication section 150. When no output stop instruction for the specific color is issued from the controlling section 220, the image processing section 230 combines the specific color portion and the non-specific color portion into original image data in the form not-yet separated by the color separating section 210, and then transmits the data to the image forming section 140 or the communication section 150.

The use of the hard disk drive 380 permits long-term retention of the image data, and hence improves the user convenience. Further, the data stored in the hard disk drive 380 is solely the non-specific color portion other than the confidential portion (specific color portion). This reduces the risk of leakage of the confidential portion. When the specific color portion is read out from the RAM 382, and when the output processing thereof is completed, the controlling section (deleting section) 220 preferably deletes the specific color portion immediately. Since the specific color portion (confidential portion) the output processing of which has been completed and hence which has become unnecessary is deleted immediately by the controlling section 220, the confidential portion is prevented from leaking out, so that the security is improved.

In Embodiment 3, the specific color portion is stored in the RAM 382. However, for example, similarly to Embodiment 2, the specific color portion may be encrypted by an encrypting section or the controlling section so as to be stored in the RAM 382 or the hard disk drive 380. When the specific color portion is stored in the hard disk drive 380, the image data containing the specific color portion can be retained for a long term. This improves the user convenience. Further, when receiving an output stop instruction from the controlling section 220, the color separating section (extracting section and output stopping section) 210 may stop the transfer of the specific color portion to the RAM 382. In this case, during the output stop, the confidential portion (specific color portion) is not stored in the RAM 382. This prevents more securely the confidential portion from leaking out.

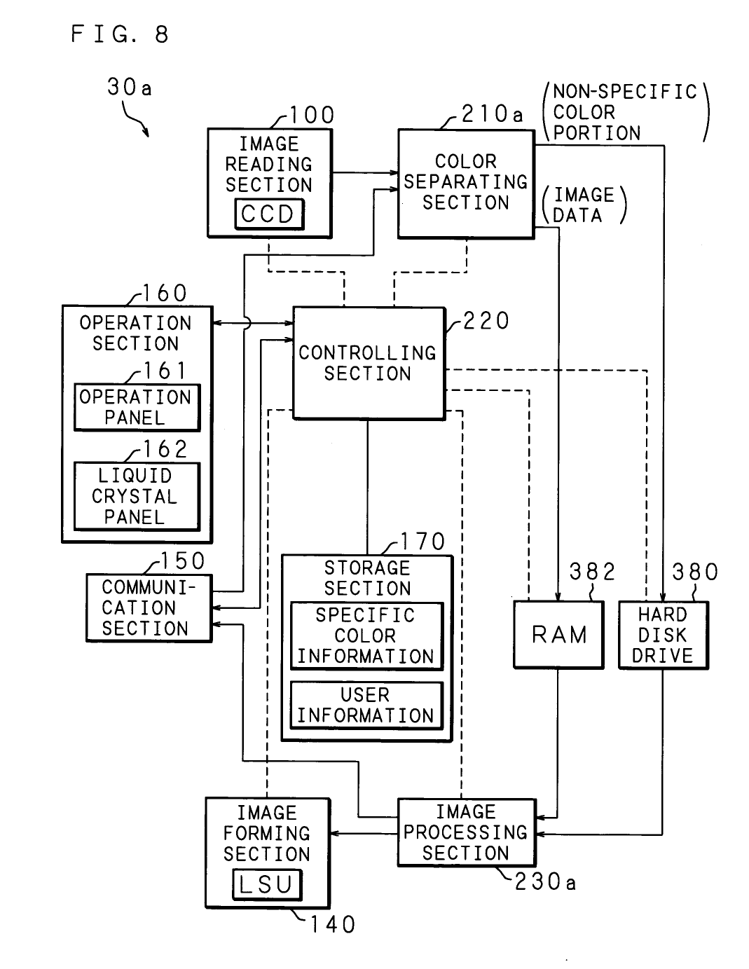

Further, in Embodiment 2 or 3, the specific color portion is stored in the second image memory 282 or the RAM 382. However, both the specific color portion and the non-specific color portion may be stored. FIG. 8 is a block diagram showing the configuration of the image processing apparatus 30a for storing image data (both the specific color portion and the non-specific color portion) into the RAM 382. The configuration of the image processing apparatus 30a is similar to that of Embodiment 3 (the image processing apparatus 30 of FIG. 7). However, the color separating section 210a extracts the specific color portion and separates the non-specific color portion. The non-specific color portion is transmitted to the hard disk drive 380, while the image data (both the specific color portion and the non-specific color portion) is transmitted to the RAM 382. The image processing apparatus 30a transmits, to the image forming section 140 or the communication section 150, the image data which includes both the specific color portion and the non-specific color portion and which is read out from the RAM 382, or alternatively the image data which does not include the specific color portion and which is read out from the hard disk drive 380.

As such, as for the separation of the image data, one possible method is that the specific color portion is extracted, so that the data is separated into the specific color portion and the non-specific color portion. Then, when the authentication is completed, the specific color portion and the non-specific color portion are combined and outputted. When the authentication is not completed, the non-specific color portion solely is outputted. Another possible method is that specific color portion is extracted, so that the data is separated into the non-specific color portion and the image data (which includes both the specific color portion and the non-specific color portion). Then, when the authentication is completed, the image data is outputted. When the authentication is not completed, the non-specific color portion solely is outputted.

### Embodiment 4

In the above-mentioned embodiments, the specific color portion is deleted, while the non-specific color portion solely is printed out (outputted), so that the-confidential portion is prevented from leaking out. However, the specific color portion may be replaced with a predetermined mark. For example, in Embodiment 2 or 3, the color separating section 210 may replace the specific color portion with an underline. Alternatively, the image processing section 230 may replace the specific color portion with an underline. Then, the image may be outputted in which the specific color portion is replaced with the underline.

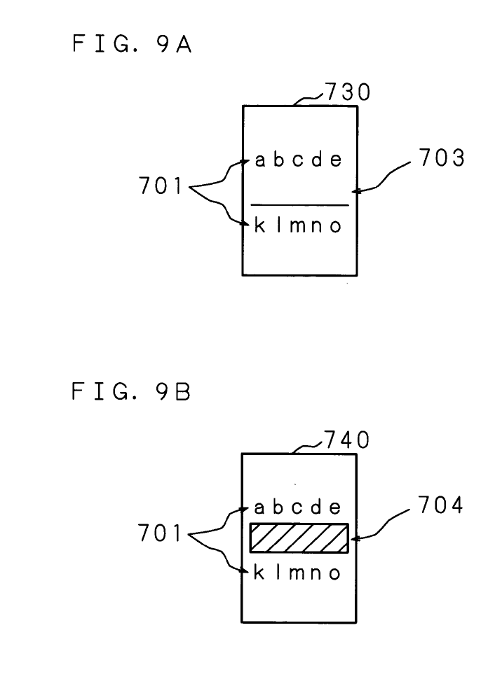

FIG. 9A is a diagram showing an example of printed-out recording paper. The example of FIG. 9A corresponds to the example of FIG. 5B. A non-specific color portion 701 and an underlined portion (specific color portion) 703 are printed out on recording paper 730. In FIG. 5B, a specific color portion 702 is not printed out (not outputted), so that the confidential portion (specific color portion) is prevented from leaking out. Nevertheless, since the non-specific color portion 701 is solely printed out, the user can misunderstand as if an error has occurred in the preparation of the document, or alternatively as if a fault has occurred in the equipment. However, when the specific color portion is indicated by the underline 703 as shown in FIG. 9A, it is clearly indicated that the non-printing of the confidential portion is intentional.

Methods for indicating clearly that the non-printing (non-outputting) of the confidential portion is intentional are not restricted to the above-mentioned one. An arbitrary pattern or mark may be used. For example, as shown in FIG. 9B, the specific color portion may be replaced with a painted-out mark 704. This also indicates clearly that the non-printing of the confidential portion is intentional.

Alternatively, when the specific color portion of the image data is not printed out (not outputted) because the controlling section 120 or 220 cannot authenticate the user, the controlling section 120 or 220 may control the liquid crystal panel 162 of the operation section (notifying section) 160 such as to display that the specific color portion is not printed out, at the timing of end of the printout. Alternatively, the communication section (notifying section) 150 may notify this situation to the computer 22 of the user. Further alternatively, a speaker (notifying section) not shown may notify the non-printing of the specific color portion by voice. Alternatively, a message may be printed out in the header portion of the printed-out recording paper (notifying means). Such notification of non-printing of the specific color portion indicates to the user clearly that the non-printing (non-outputting) of the confidential portion is intentional. This improves the convenience.

### Embodiment 5

The above-mentioned specific color portion is preferably composed of characters. For example, in case that a specific color is contained in color graphics, even when the specific color portion is deleted (for example, converted into white), the deleted portion (specific color portion) can easily be inferred in some cases depending on the contents of the graphics. In the case that the specific color portion is composed of characters, the subject matter of the confidential portion (specific color portion) is hardly inferred from the result of printout. And hence, the security is maintained at a high level.

In case that a specific color portion is a part of graphics, the color restricting section 110 (or alternatively the color separating section 210) performs extraction (or separation) preferably with considering as if the entirety of the graphics is a specific color portion. In case of graphics, even when the specific color portion is deleted, the deleted portion (specific color portion) can easily be inferred in some cases depending on the contents of the graphics. However, when the entirety of the graphics is deleted, the graphics containing the confidential portion (specific color portion) is prevented from being printed out. This improves the security.

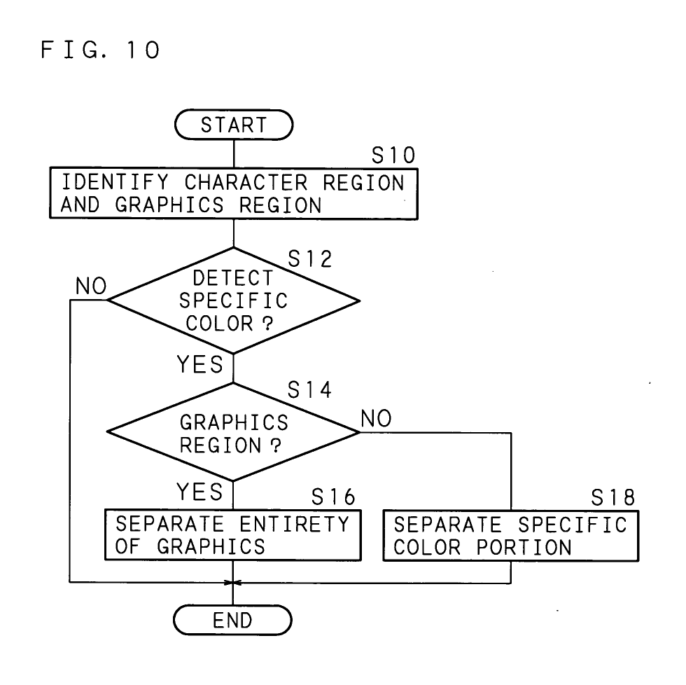

FIG. 10 is a flowchart showing the procedure of separating a specific color when the specific color is contained in graphics. The present embodiment is described below for the case that the image processing apparatus 20 or 30 (FIG. 6 or 7) of Embodiment 2 or 3 is used. The color separating section 210 or the controlling section 220 identifies a character region and a graphics region within the image data received from the image reading section 100 or the communication section 150, according to a known image recognition scheme (S10). After the identification of the character region and the graphics region, the color separating section 210 detects the specific color (S12). When the specific color is detected in the character region (S12: YES and S14: NO), the color separating section 210 separates the specific color portion (S18). When the specific color is detected in the graphics region (S12: YES and S14: YES), the color separating section 210 separates the entirety of the graphics in which the specific color has been detected (S16). When a plurality of specific color portions are detected, the processes S14-S18 are performed similarly.

### Embodiment 6

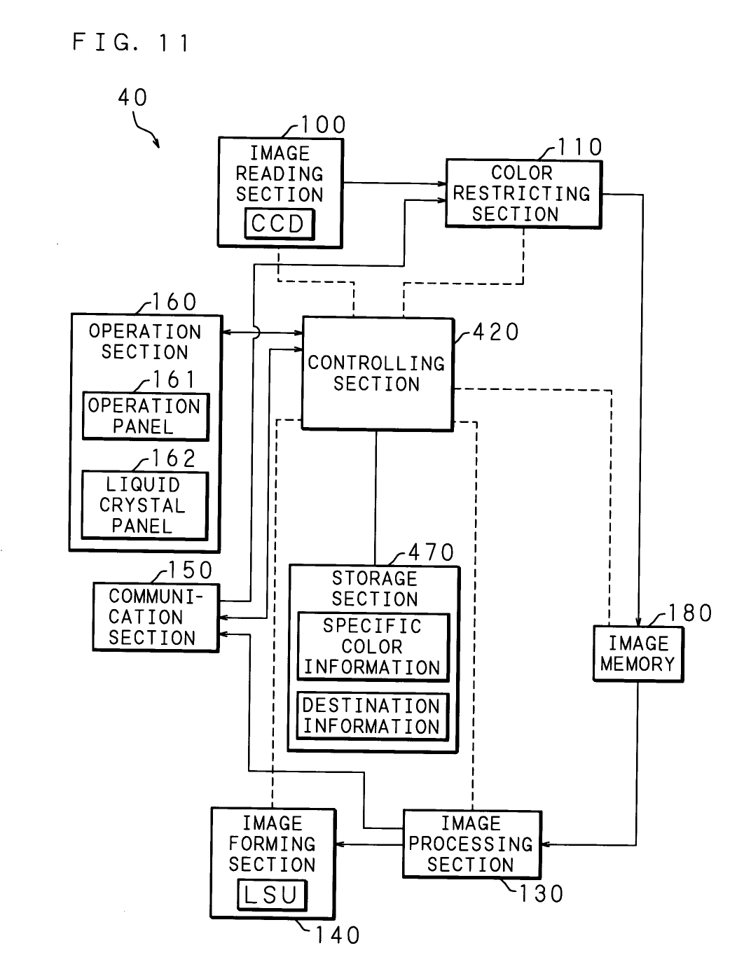

In the above-mentioned embodiments, the specific color portion is printed out when the user authentication for the output requestor is completed. However, for example, when a document containing a confidential portion is to be transmitted from the communication section 150 by facsimile, the transmission or the transmission stopping of the specific color portion can be switched depending on the destination. FIG. 11 is a block diagram showing an example of image processing apparatus 40 for stopping the transmission of the specific color portion depending on the destination. The image processing apparatus 40 comprises: an image reading section 100; a communication section 150; a color restricting section 110; an image memory 180; an image processing section 130; an image forming section 140; a controlling section 420; a storage section 470; and an operation section 160.

In the present embodiment, the storage section (destination storage section) 470 stores destination information such as a facsimile number of a destination to which the transmission of a confidential portion is allowed. When receiving a facsimile transmission operation such as a facsimile number through the operation panel 161 of the operation section 160, the controlling section 420 checks whether the received facsimile number is registered in the destination information stored in the storage section 470 or not. When the facsimile number is not registered, the controlling section 420 issues an output stop instruction for the specific color to the color restricting section (extracting section and transmission stopping section) 110.

When the facsimile number of the destination is registered in the destination information in the storage section 470, the color restricting section 110 does not delete the specific color, so that the image data received by the color restricting section 110 is transmitted intactly by facsimile, for example, as shown in FIG. 5C. When the facsimile number of the destination is not registered in the destination information in the storage section 470, the controlling section 420 issues an output stop instruction to the color restricting section 110. Thus, the color restricting section 110 deletes (for example, converts into white) the specific color, so that the image data in which the specific color portion has been deleted is transmitted by facsimile, for example, as shown in FIG. 5B.

Since the specific color portion is transmitted solely to the destination having been registered in advance, the confidential portion is prevented from leaking out, so that the security is improved. Further, the specific color portion can be transmitted to the specific destination. This improves the user's convenience, with maintaining a high security level. Further, since the confidentiality is ensured by preparing the confidential portion in the specific color, a facsimile transmission document containing a confidential portion can be prepared easily and efficiently.

In the present embodiment, the transmission of the specific color portion is stopped depending on the destination. However, in the transmission, an output instruction or an output stop instruction for the specific color portion may be received through the operation section 160 (operation panel 161) or the communication section 150 (computer 22). Then, depending on the received instruction, the controlling section 420 issues an output stop instruction to the color restricting section 110, so that the transmission of the specific color portion is stopped.

When the specific color portion is transmitted, the controlling section 420 may encrypt the specific color portion or the entirety of the image data. When the confidential portion (specific color portion) to be transmitted to an external communication line is encrypted, the confidential portion is prevented from leaking out during the transmission, so that the security is improved. As for the encryption, the specific color portion or the entirety of the image data may be encrypted using predetermined encryption scheme, keys, and the like at the transmission of the specific color portion, so that the decryption may be performed in the facsimile machine on the receiver side. In contrast, the encryption may be configured such that a specific user solely can perform the decryption on the receiver side.

Similarly to Embodiment 2 or 3 (FIG. 6 or 7), the color restricting section 110 may be replaced with the color separating section 210. Further, the image memory 180 may be replaced with the first image memory 280 and the second image memory 282 (or alternatively the hard disk drive 380 and the RAM 382), so that the specific color portion and the non-specific color portion separated in the color separating section 210 may be combined and outputted in the image processing section 230. Further alternatively, the non-specific color portion may solely be outputted.

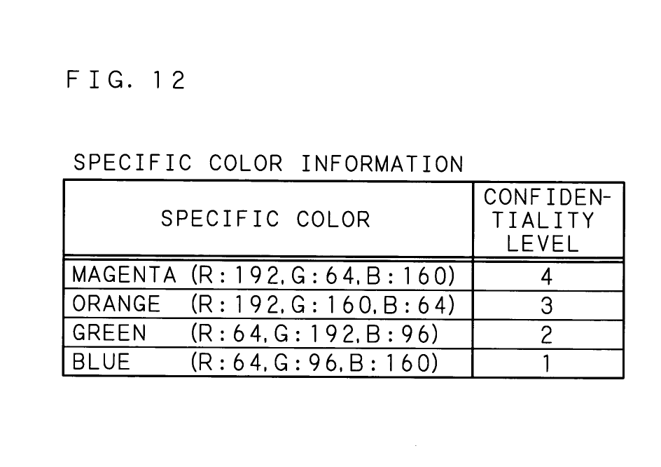

In the above-mentioned embodiments, a plurality of specific colors may be used. In this case, any one from a plurality of the specific colors can be used. This improves the user's convenience. Further, a confidentiality level may be set for each of a plurality of the specific colors, so that the outputting or the output stopping may be controlled depending on the confidentiality level. FIG. 12 is a diagram showing an example of specific color information in which confidentiality levels (importance levels) are set. In the example of FIG. 12, the specific colors of magenta, orange, green, and blue are set in the descending order of confidentiality level. For example, the controlling section 120, 220, or 420 may control the outputting or the output stopping for the colors (magenta and orange) of the two highest confidentiality levels, and may perform outputting always for the colors (green and blue) of the two lowest confidentiality levels. Since the outputting or the output stopping is controlled depending on the color used, the user's convenience is improved in the document preparation and outputting.

In facsimile transmission, a confidentiality level (importance level) where the transmission is allowed may be set for each destination. For example, a confidentiality level where the transmission is allowed for each destination is set in the destination information in the storage section 470. Then, the controlling section 420 transmits the specific color of the confidentiality level allowed for the destination, but deletes (stops the transmission) the specific color of the confidentiality level not allowed for the destination. Similarly, a confidentiality level where the controlling section 120, 220, or 420 allows the outputting may be set for each of the copying, printing, or facsimile transmission. For example, the controlling section 120, 220, or 420 may controls the operation such that orange, green, and blue during the printing are outputted always, that green and blue during the copying are outputted always, and that blue during the facsimile transmission is outputted always.

### Embodiment 7

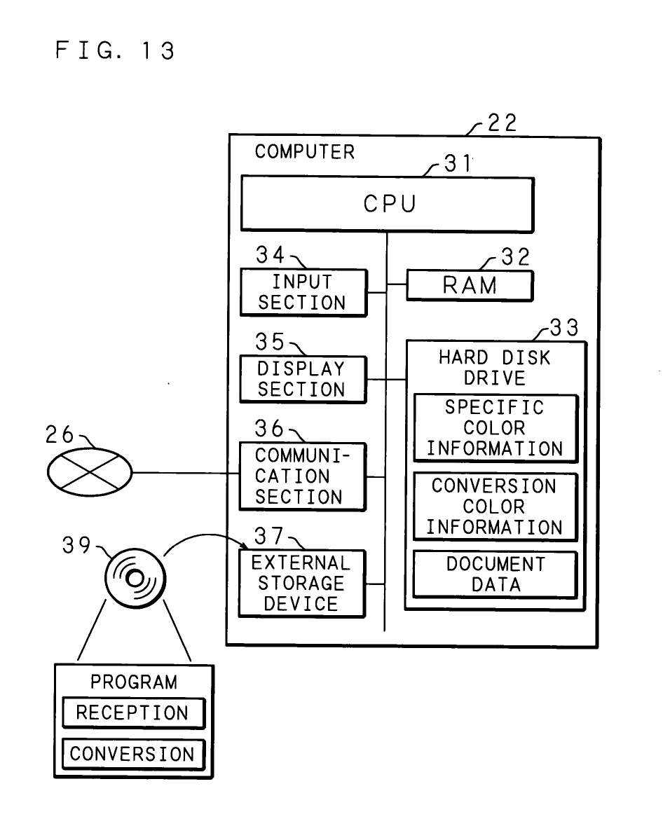

FIG. 13 is a block diagram showing an example of configuration of a computer (information processing apparatus) 22 connected to the above-mentioned image processing apparatus 10, 20, 30, 30a, or 40 according to the invention. The computer 22 comprises: a CPU (central processing unit) 31; a RAM 32; a hard disk drive 33; an input section 34 such as a keyboard; a display section 35 such as a monitor unit; a communication section 36 connected to a network 26; and an external storage device 37 such as a CD-ROM (compact disc-read only memory) drive.

The hard disk drive 33 stores specific color information concerning the specific color received from the image processing apparatus 10, 20, 30, 30a, or 40 or the communication section (transmitting section) 150 by the communication section (reception section) 36 of the computer 22. In the image processing apparatus 10, 20, 30, 30a, or 40, under the control of the controlling section 120, 220, or 420, the specific color information stored in the storage section 170 or 470 is transmitted from the communication section 150 to the computer 22.

The hard disk drive 33 stores also conversion color information concerning the importance color specified individually by each user. When receiving from the inputting section 34 a printout instruction for document data stored in the hard disk drive 33, the CPU 31 serves as means (converting means) for converting into the specific color the importance color in the document data to be printed out, on the basis of the conversion color information and the specific color information stored in the hard disk drive 33. The converted image data is transmitted from the communication section 36 to the image processing apparatus 10, 20, 30, 30a, or 40.

For example, a computer program recorded in a recording medium 39 such as a CD-ROM is read out by the external storage device 37 and then stored into the hard disk drive 33. After that, the computer program is loaded onto the RAM 32 and then executed on the CPU 31. Such a method allows the CPU 31 to serve as each piece of the above-mentioned means. The computer program may be received from another device by the communication section 36, and then stored into the hard disk drive 33.

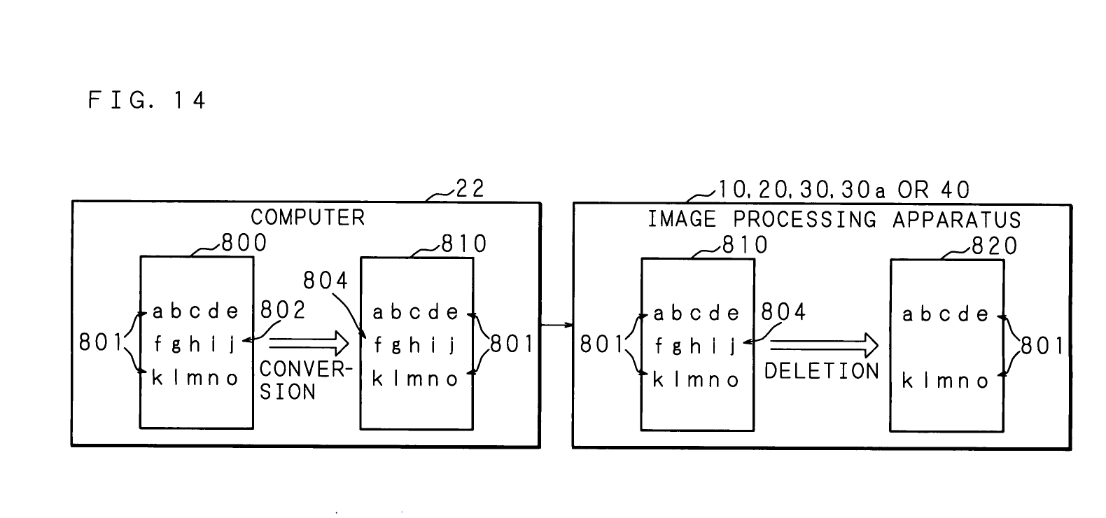

FIG. 14 is a diagram showing an example of printout of document data. For example, when the color (importance color) of an important portion 802 of the document data 800 stored in the hard disk drive 33 is blue, and when the color of the other portion 801 is black, and further when the specific color is red, the CPU 31 of the computer 22 converts the importance color (the important portion 802) into the specific color (the specific color portion 804), so as to generate document data 810 as described above. This generated document data 810 is transmitted from the communication section 36 to the image processing apparatus 10, 20, 30, 30a, or 40, so that document data 820 is printed in a state that the specific color portion 804 is deleted (for example, converted into white) as described above.

The conversion color information stored in the hard disk drive 33 can be updated by the CPU 31, for example, in response to a selection operation through the input section 34. The user preparing the document data by using the computer 22 is not restricted by the specific color defined in the image processing apparatus 10, 20, 30, 30a, or 40, and hence can use an arbitrary color in the important portion. This increases the degree of freedom in document preparation, and hence improves the convenience.

In Embodiment 7 described above, the importance color specified individually by each user is converted into the specific color. However, the specific color in the printed-out document may be converted into a non-specific color. For example, the conversion color information in the hard disk drive 33 may include the registration of a non-specific color, so that the CPU 31 may convert the specific color portion in the document data into the non-specific color. When the user uses the specific color regardless of the importance level, the specific color portion may be converted into the non-specific color. This avoids the deletion in the image processing apparatus 10, 20, 30, 30a, or 40. Further, when the specific color portion is desired to be printed out, the specific color portion may be converted into the non-specific color. This avoids similarly the deletion in the image processing apparatus 10, 20, 30, 30a, or 40.

Alternatively, the CPU 31 may convert the specific color portion into a deletion color or a predetermined mark. For example, when the printout is performed onto white paper, the specific color portion may be converted into white (the deletion color). When the specific color portion is converted into the deletion color, the image processing apparatus 10, 20, 30, 30a, or 40 does not need to delete (for example, convert into white) the specific color. This reduces the load of output processing in the image processing apparatus 10, 20, 30, 30a, or 40.

The above-mentioned conversion of the importance color portion in the document data into the specific color and the above-mentioned conversion of the specific color portion in the document data into the non-specific color may be performed simultaneously. For example, the conversion color information may include the registration of the importance color and the non-specific color, so that in response to an instruction from the inputting section 34, the CPU 31 may convert the specific color portion into the non-specific color, and then convert the importance color portion into the specific color. Further, under the control of the CPU 31, an output instruction or an output stop instruction for the specific color portion received by the input section 34 may be transmitted from the communication section 36 to the image processing apparatus 10, 20, 30, 30a, or 40. The image data to be transmitted to the image processing apparatus 10, 20, 30, 30a, or 40 may be encrypted by the CPU 31.

### Embodiment 8

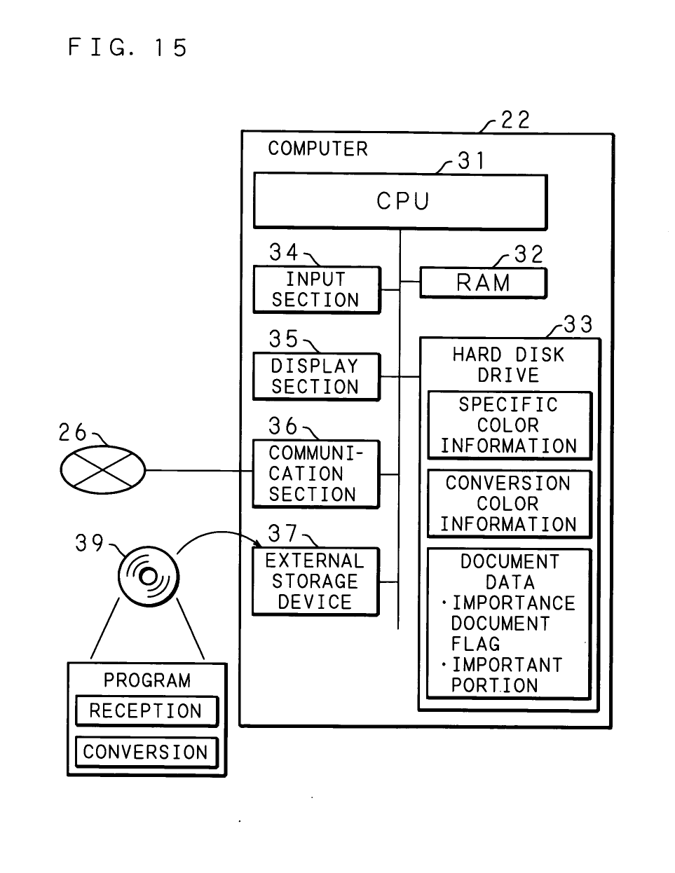

FIG. 15 is a block diagram showing an example of configuration of a computer 22 connected to the above-mentioned image processing apparatus 10, 20, 30, 30a, or 40. This configuration is similar to that of the computer 22 shown in FIG. 13. The hard disk drive 33 stores conversion color information concerning: the importance color in document data to be converted into the specific color; and the non-specific color used as the destination color in the conversion of the specific color in the document data. The hard disk drive 33 stores also the document data to which an importance document flag (for example, flag “1” indicates an important document, while flag “0” indicates a non-important document) is added. On the basis of the importance document flag, the CPU 31 converts the importance color into the specific color, or alternatively converts the specific color into the non-specific color.

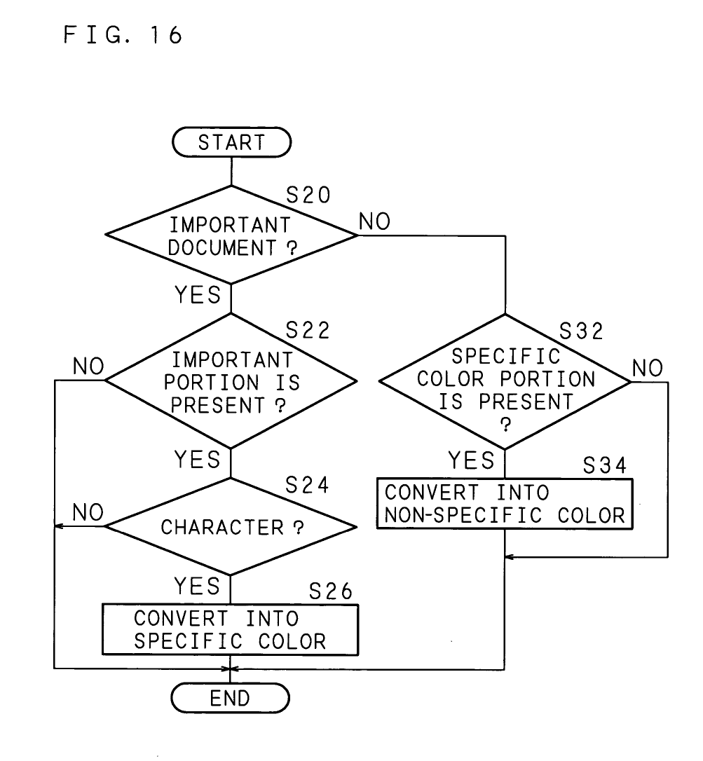

FIG. 16 is a flowchart showing the procedure of color conversion. When receiving from the input section 34 a printout instruction for document data stored in the hard disk drive 33, the CPU 31 performs color conversion on the basis of the importance document flag, the specific color information, and the conversion color information of the to-be-printed-out document data stored in the hard disk drive 33. In case of an important document (importance flag=“1”) (S20: YES), an important portion (importance color portion) is present (S22: YES). Further, in case that the important portion is composed of characters (S24: YES), the CPU 31 converts the importance color portion into the specific color (S26). In case of a non-important document (importance flag=“0”) (S20: NO), and in case that a specific color portion is present (S32: YES), the CPU 31 converts the specific color portion into the non-specific color (S34).

In Embodiment 8, the important portion is converted into the specific color. However, a portion in a predetermined font or style such as an underlined portion and an italic font portion may be converted into the specific color.

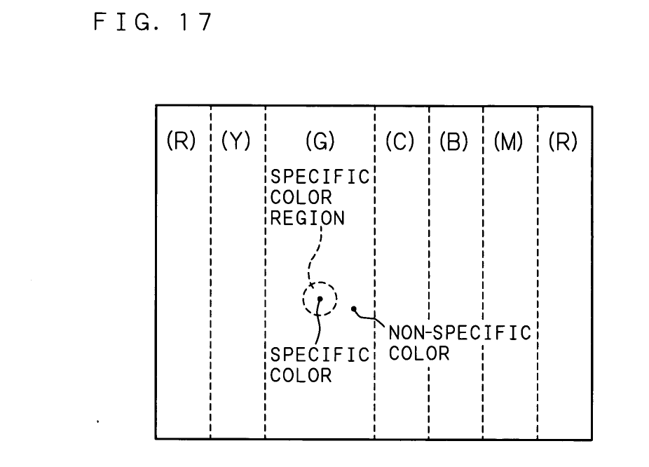

The specific color may be specified within a somewhat spread region. FIG. 17 is a color map diagram showing schematically the distribution of the colors used by the computer 22. In the example of FIG. 17, the color distribution is generally divided into the areas of R (red), Y (yellow), G (green), C (cyan), B (blue), and M (magenta). For example, when the specific color belongs to the G area, a specific color region including the specific color within the G area may be treated as the specific color. For example, when the specific color is read out by the image reading section 100, or alternatively when the specific color is printed out by the image forming section 140, the read-out specific color or the printed-out specific color can slightly be different from the original specific color. Thus, when the specific color is specified as a specific color region as described above, even the specific color slightly different from the original one can be detected appropriately. The color map and the setting of the specific color region are stored in advance in the hard disk drive 33 or the like.

In Embodiment 7 or 8, a non-specific color may be set within the same area (G area in the example of the figure) as that of the specific color of FIG. 17, while the CPU 31 may convert the specific color portion into the non-specific color. This allows the specific color portion to be printed out (outputted) in the non-specific color similar to the specific color. For example, the copying of the specific color portion may be prevented, whereas the printer outputting may be allowed in the non-specific color similar to the specific color. This improves the convenience in confidential document preparation. For example, in case of graphics data having little confidentiality but containing the specific color, when the specific color is converted into the non-specific color similar to the specific color, the graphics can be printed out in a state similar to the original one.

Embodiments 1-8 described above have the following effects. That is, the outputting or the output stopping of the specific color portion (important portion) can be switched depending on the result of authentication for the output requestor. This improves the user's convenience, and avoids that the copying, printing, or facsimile transmission of a document containing an important portion is carried out by many and unspecified persons. Further, the transmission or the transmission stopping of the specific color portion (important portion) can be switched depending on the destination. Accordingly, even in case that an incorrect facsimile number is inputted, the important portion is not transmitted to the incorrect destination. Still, the user's convenience is improved.

Further, the outputting or the output stopping of the specific color portion (important portion) can be switched on the basis of instruction. This improves the user's convenience. Further, the determination such as authentication for determining the outputting or the output stopping and the extraction of the specific color portion can be performed in parallel. This permits efficient output processing of the image data. Furthermore, the specific color portion the outputting of which has been stopped can be indicated by a predetermined mark such as an underline. This permits clear notification to the user that the non-printing is intentional. Further, specific color information can be transmitted from the computer to the image processing apparatus. This allows the computer to process the print data (image data) to be transmitted from the computer to the image processing apparatus. For example, an importance color used individually by a user can be converted into the specific color specified by the image processing apparatus. This allows the user to set the specific color flexibly, and hence improves the convenience.

### Embodiment 9

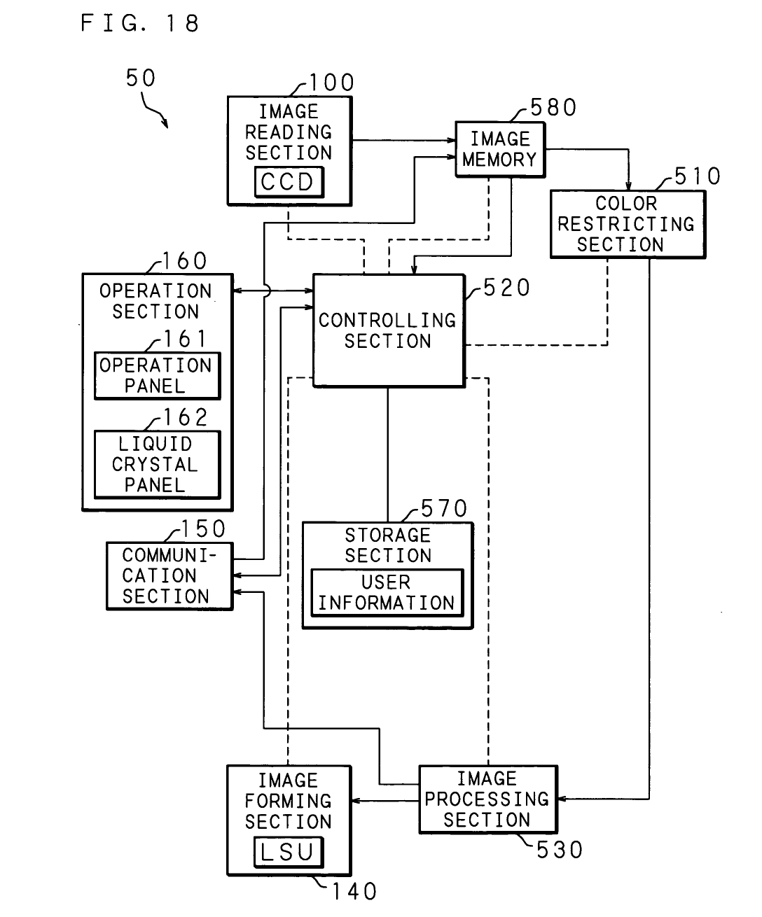

FIG. 18 is a block diagram showing the configuration of another image processing apparatus 50 according to the invention. As shown in FIG. 18, the image processing apparatus 50 comprises: an image reading section 100; a communication section 150; an image memory 580 connected to the image reading section 100 and the communication section 150; a color restricting section 510 connected to the image memory (storage section) 580; an image processing section 530 connected to the color restricting section 510 and the communication section 150; an image forming section 140 connected to the image processing section 530; a controlling section 520 connected to these sections; and a storage section 570 and an operation section 160 each connected to the controlling section 520. Each section of the image processing apparatus 50 is controlled by the controlling section 520. The configuration of the image reading section 100, the image forming section 140, the communication section 150, and the operation section 160 is the same as that of Embodiment 1.

The image reading section 100 reads the image data of an original document, and then transmits the read-out image data to the color restricting section 510 via the image memory 580. For example, image data composed of pixels expressed by the three color components of R (red), G (green), and B (blue) is stored in the image memory 580. The communication section 150 controls the communication with a network 26. For example, the communication section 150 receives image data from the computer 22 (see FIG. 2), and transmits the received image data to the color restricting section 510 via the image memory 580. For example, image data composed of pixels (Y, M, C) expressed by the three color components of Y (yellow), M (magenta), and C (cyan), or alternatively pixels expressed by BK (black), is stored in the image memory 580.

The controlling section 520 serves as means (acquiring means) for acquiring specific color information concerning the specific color added to the image data stored in the image memory 580. The specific color information is added to the image data according to a predetermined rule. For example, a bar code corresponding to the specific color information may be added to the image data. Alternatively, a pattern corresponding to the specific color information may be added to the image data by using a color hardly visible to human eyes. Further alternatively, the image data may be slightly changed in correspondence to the specific color information. Further, for the purpose of ensured recognition, the specific color information may be provided at a fixed position such as an edge of the image data.

The controlling section 520 may identify the bar code (specific color information) in the image data through an OCR or the like, so as to acquire the specific color corresponding to the bar code on the basis of the correspondence relation between the bar code and the specific color stored in the storage section 570 in advance. Further, the controlling section 520 may identify a pattern or a changed portion (specific color information) in the image data through an OCR or the like, so as to acquire the specific color corresponding to the identified pattern or change on the basis of the correspondence relation between the type of the pattern or the change and the specific color stored in the storage section 570 in advance.

The storage section 570 stores user information concerning a user who is allowed to execute the output of a specific color portion of image data. The controlling section 520 serves as means (an authenticating section) for authenticating the output requestor of the image data received by the image reading section 100 or the communication section 150. When the authentication is failed, the controlling section 520 issues an output stop instruction (including information concerning the specific color) for the specific color portion, to the color restricting section 510.

When receiving an output stop instruction for a specific color portion from the controlling section 520, the color restricting section 510 serves as means (an extracting section) for extracting the specific color portion of the image data read out from the image memory 580. Further, when receiving an output stop instruction for a specific color portion from the controlling section 520, the color restricting section 510 serves as means for stopping the output of the specific color portion of the image data read out from the image memory 580. For example, when the printout is performed onto white paper, the color restricting section 510 may convert the specific color into a deletion color (white), or alternatively may paint out the specific color portion with white or the like. The image data the specific color portion of which has been deleted is transmitted from the color restricting section 510 to the image processing section 530.

When no output stop instruction is issued from the controlling section 520, the color restricting section 510 transfers the received image data intactly to the image processing section 530. In response to an instruction, for example, from the operation section 160, the image processing section 530 performs image processing such as the enlargement and the contraction of the image data received from the color restricting section 510.

When the authentication for the output requestor of the image data is failed, the specific color information is deleted. For example, the controlling section 520 may issue a deletion instruction for the specific color information to the color restricting section 510, so that the color restricting section 510 may delete the specific color information. Further, when the authentication is failed, the controlling section 520 may delete the specific color information of the image data stored in the image memory 580. Alternatively, the controlling section 520 may issue a deletion instruction for the specific color information to the image processing section 530, so that the image processing section 530 may delete the specific color information.

In response to an instruction from the controlling section 520, the image processing section 530 transmits the image data received from the color restricting section 510, to the image forming section 140 or the communication section 150. The image forming section 140 comprises an LSU or the like and, for example, forms an electrostatic latent image corresponding to the image data received from the image processing section 530 onto a photosensitive body, so as to form (print out) an image onto recording paper. The communication section 150 transmits the image data received from the image processing section 530 to a destination (the computer 22 or an external facsimile machine) specified by the controlling section 520.

In the image processing apparatus 50, for example, when the image reading section 100 reads an original color document, the controlling section 520 extracts specific color information from the read-out image data. When the specific color information is extracted, authentication information such as a password is received through the operation section 160, so that the controlling section 520 compares the received authentication information with the user information stored in the storage section 570, so as to perform authentication.

When the authentication is failed, the controlling section 520 issues an output stop instruction (including the specific color information and a deletion instruction for the specific color information) to the color restricting section 510. The color restricting section 510 then deletes the specific color portion (and the specific color information) of the image data read out from the image memory 580. Then, the image data the specific color portion (and the specific color information) of which has been deleted is transmitted to the image processing section 530. When the authentication is successful, or alternatively when the specific color information is not extracted, the controlling section 520 does not issue an output stop instruction for the specific color to the color restricting section 510. Thus, the color restricting section 510 transmits intactly the image data read out from the image memory 580, to the image processing section 530. The image data transmitted to the image processing section 530 is further transmitted to the image forming section 140 and then printed out onto recording paper.

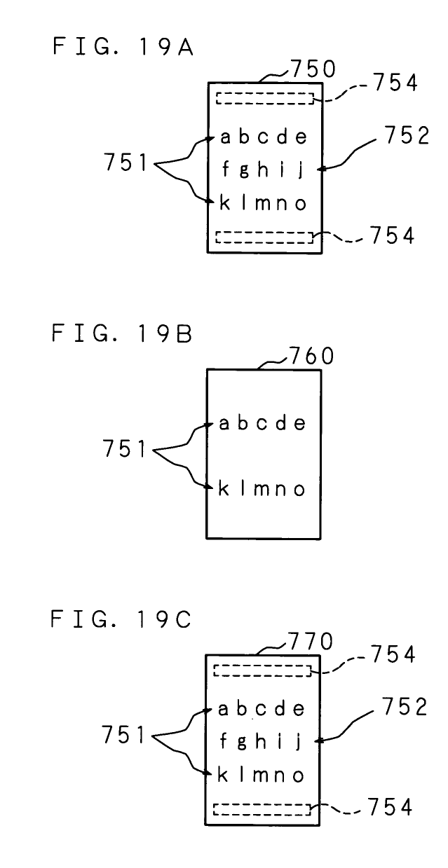

FIG. 19A is a diagram showing an example of original document. FIGS. 19B and 19C are diagrams each showing an example of printed-out recording paper. The original document 750 of FIG. 5A comprises: a specific color portion (confidential portion) 752 prepared in red or the like; a non-specific color portion 751 prepared in black; and a'specific color information portion 754. As described above, when the authentication is failed, the controlling section 520 controls the color restricting section 510 to delete the specific color portion 752 (and the specific color information portion 754). As a result, as shown in FIG. 19B, the non-specific color portion 751 is recorded (outputted) on the recording paper 760, whereas the outputting of the specific color portion 752 (and the specific color information portion 754) is stopped, and hence these portions are not recorded. When the authentication is successful, as described above, the color restricting section 510 transmits the image data intactly. As a result, as shown in FIG. 19C, both the specific color portion 752 and the non-specific color portion 751, together with the specific color information portion 754, are recorded on the recording paper 770.

The present embodiment is described for the case that the data is printed out on recording paper. However, the image data transmitted to the image memory 580 may be further transmitted through the color restricting section 510 and the image processing section 530 to the communication section 150, so as to be transmitted by facsimile. Alternatively, the image data received from the computer 22 by the communication section 150 may undergo output processing. In addition to the authentication scheme that the operation section 160 or the communication section 150 receives a password, the authentication may be performed by another scheme that an acquiring section provided in the image processing apparatus 50 acquires authentication information in a radio frequency tag or an IC card, so as to transmit the authentication information to the controlling section 520. Other various authentication schemes may also be used such as a scheme that the communication section 150 receives the IP address of the computer 22 so as to use the IP address in the authentication. In addition to the method that the color image read out by the image reading section 100 is outputted intactly in color, the output of the image data containing the specific color portion may be performed by a method that the color image read out by the image reading section 100 is printed out or transmitted in black and white, for example, in case that the image forming section 140 can process only black and white printing, or alternatively in case of facsimile transmission. Here, it should be noted that since the specific color is changed into black and white, no specific color information is added.

As such, the specific color concerning the received image data is acquired, so that the copying or the printing of the confidential or important portion prepared in the acquired specific color is restricted. This improves the security. Further, the outputting of the specific color acquired from the image data is restricted. This permits the changing of the specific color for each piece of the image data. Thus, the color used in the confidential or important portion can be set arbitrarily. This improves the user's convenience in document preparation and document outputting.

### Embodiment 10

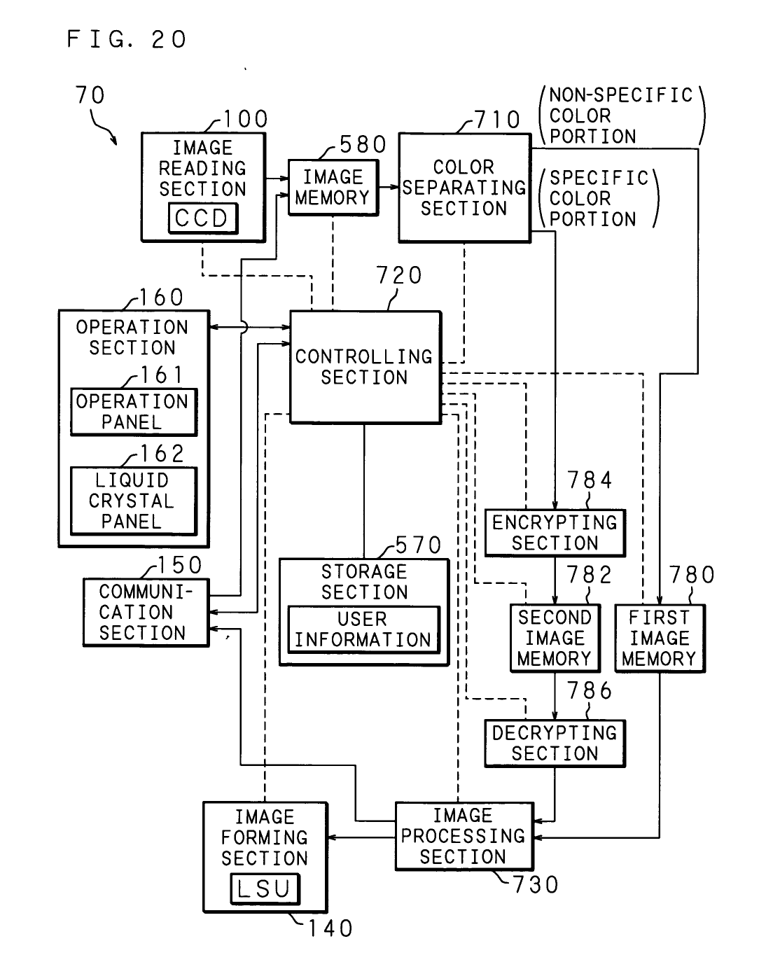

FIG. 20 is a block diagram showing the configuration of another image processing apparatus 70 according to the invention. The image processing apparatus 70 comprises: an image reading section 100; a communication section 150; an image memory 580; an image processing section 730; an image forming section 140; a controlling section 720; an operation section 160; and a storage section 570. The image processing apparatus 70 further comprises: a color separating section 710 connected to the image memory 580; a first image memory 780 connected between the color separating section 710 and the image processing section 730; an encrypting section 784 connected to the color separating section 710; a second image memory 782 connected to the encrypting section 784; and a decrypting section 786 connected between the second image memory 782 and the image processing section 730. These sections are controlled by the controlling section 720. The encrypting section 784 may be integrated with the color separating section 710. The decrypting section 786 may be integrated with the image processing section 730.

The color separating section (extracting section) 710 receives information concerning the specific color from the controlling section 720, so as to separate the image data received from the image memory 580 into the specific color portion and the non-specific color portion. The separated specific color portion is transmitted to the encrypting section 784, while the non-specific color portion is transmitted to the first image memory 780. The encrypting section 784 encrypts the specific color portion received from the color separating section 710, and then transmits the encrypted specific color portion to the second image memory 782. The decrypting section 786 decrypts the encrypted specific color portion stored in the second image memory 782, and then transmits the decrypted specific color portion to the image processing section 730.

In response to an output stop instruction issued from the controlling section 720, the image processing section 730 stops the output of the specific color portion. When no output stop instruction for the specific color is issued from the controlling section 720, the image processing section 730 reads the non-specific color portion and the specific color portion from the first image memory 780 and the second image memory 782, and then combines the non-specific color portion and the specific color portion into original image data in the form not-yet separated by the color separating section 710, and then transmits the data to the image forming section 140 or the communication section 150. When an output stop instruction for the specific color is issued from the controlling section 720, the image processing section 730 reads out the non-specific color portion stored in the first image memory 780, and then transmits solely the non-specific color portion to the image forming section 140 or the communication section 150.

In Embodiment 10, the first image memory 780 and the second image memory 782 are separate to each other. However, the first image memory 780 and the second image memory 782 may be integrated into an identical image memory. In this case, the storage region is separated into a first storage region and a second storage region, so that the first storage region stores the non-specific color portion, while the second storage region stores the encrypted specific color portion: Further, encryption and decryption may be performed in the controlling section 720.

Since the specific color portion is encrypted and stored in an image memory (second image memory 782), even in case that the contents of the image memory is read out, the subject matter of the encrypted confidential portion (specific color portion) does not leak out. Further, when receiving an output stop instruction from the controlling section 720, the color separating section (extracting section) 710 may stop the transfer of the specific color portion to the encrypting section 784. In this case, during the output stop, the confidential portion (specific color portion) is not stored in the second image memory 782. This prevents more securely the confidential portion from leaking out.

The first image memory 780 may be composed, for example, of a hard disk drive, while the second image memory 782 may be composed, for example, of a RAM. In this case, the specific color portion is stored in the RAM only temporarily. This prevents more securely the confidential portion from leaking out. Further, since the specific color portion is stored in the RAM only temporarily, the encrypting section 784 and the decrypting section 786 may be omitted, so that encryption itself may be omitted.

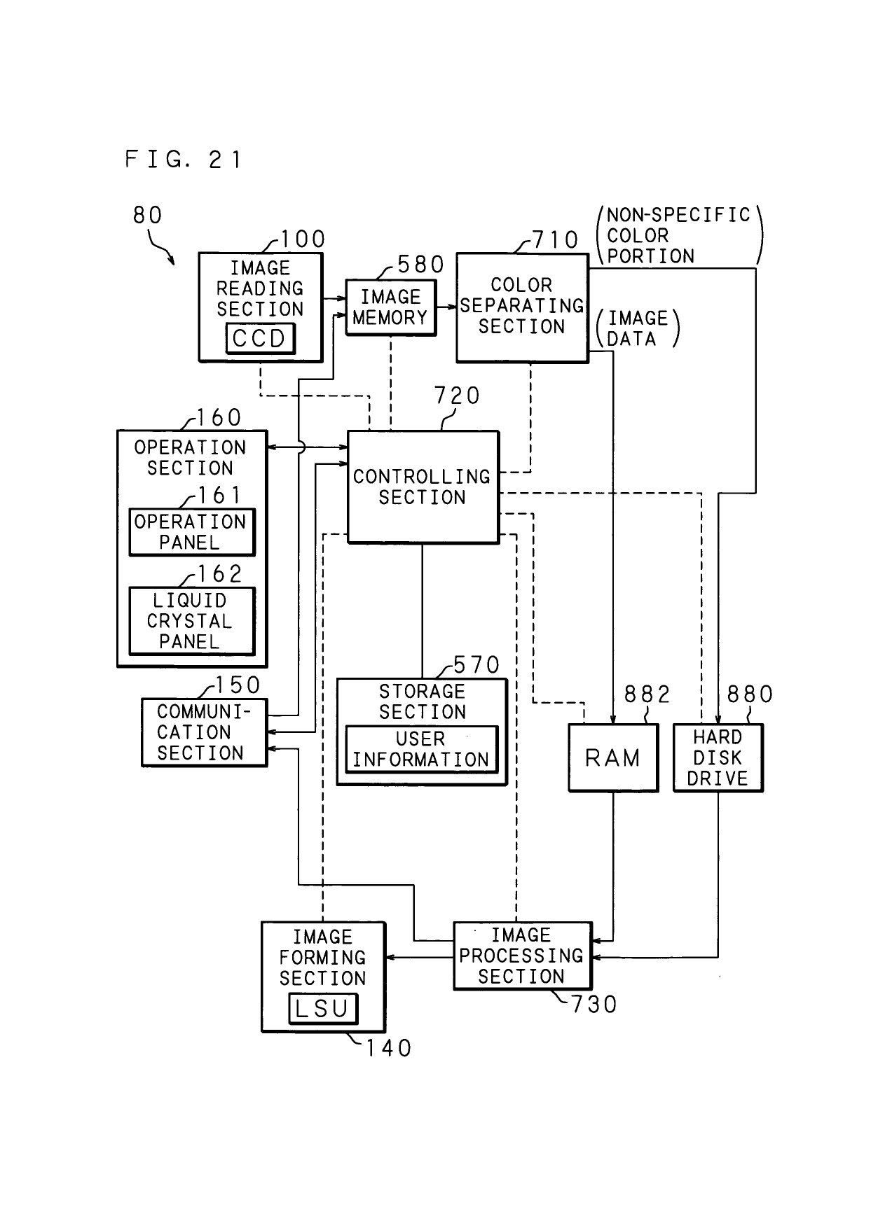

Further, in Embodiment 10, the specific color portion is stored in the second image memory 782. However, both the specific color portion and the non-specific color portion may be stored. FIG. 21 is a block diagram showing the configuration of the image processing apparatus 80 for storing image data (both the specific color portion and the non-specific color portion) into a RAM. The configuration of the image processing apparatus 80 is similar to that of Embodiment 10 (the image processing apparatus 70 of FIG. 20). However, the first image memory 780 is composed of a hard disk drive 880, while the second image memory 782 is composed of a RAM 882. Further, the encrypting section 784 and the decrypting section 786 are omitted. Furthermore, the color separating section 710 extracts the specific color portion. The non-specific color portion is transmitted to the hard disk drive 880, while the image data (both the specific color portion and the non-specific color portion) is transmitted to the RAM 882. The image processing apparatus 730 transmits, to the image forming section 140 or the communication section 150, the image data (which includes both the specific color portion and the non-specific color portion) read out from the RAM 882, or alternatively the non-specific color portion (the image data which does not include the specific color portion) read out from the hard disk drive 880.

As such, one possible method is that the image data is separated into the specific color portion and the non-specific color portion. Then, when the authentication is successful, the specific color portion and the non-specific color portion are combined and outputted. When the authentication is failed, the non-specific color portion solely is outputted. Another possible method is that the data is separated into the image data (which includes both the specific color portion and the non-specific color portion) and the non-specific color portion. Then, when the authentication is successful, the image data is outputted. When the authentication is failed, the non-specific color portion solely is outputted.

### Embodiment 11

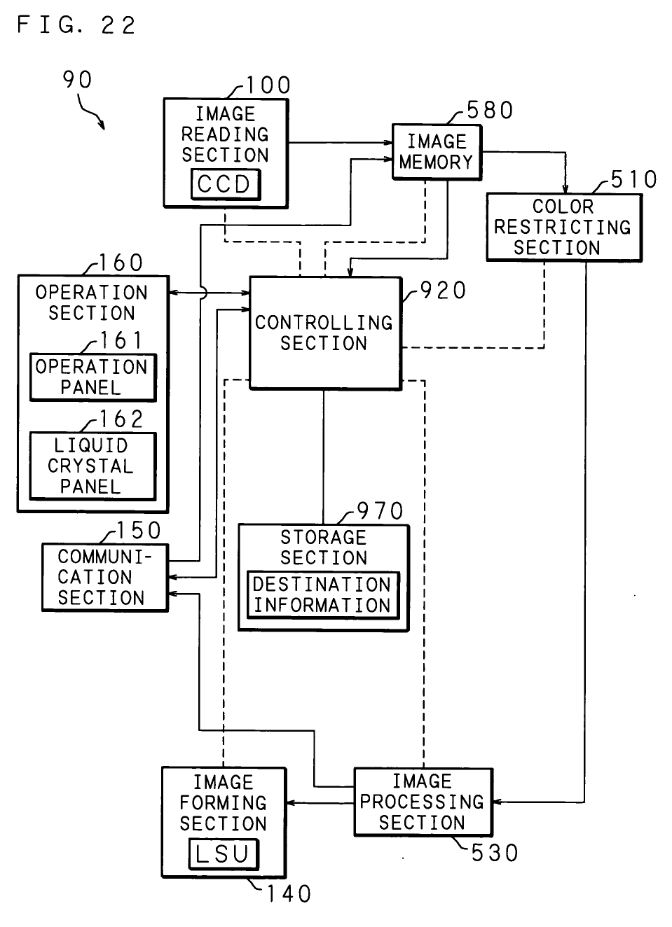

In Embodiments 9 and 10 described above, the specific color portion is printed out when the user authentication for the output requestor is successful. However, for example, when a document containing a confidential portion (specific color portion) is to be transmitted from the communication section 150 by facsimile, the transmission or the transmission stopping of the specific color portion can be switched depending on the destination. FIG. 22 is a block diagram showing an example of image processing apparatus 90 for stopping the transmission (output) of the specific color portion depending on the destination. The image processing apparatus 90 comprises: an image reading section 100; a communication section 150; an image memory 580; a color restricting section 510; an image, processing section 530; an image forming section 140; a controlling section 920; a storage section 970; and an operation section 160.

In the present embodiment, the storage section (destination storage section) 970 stores destination information such as a facsimile number of a destination to which the transmission of a confidential portion (specific color portion) is allowed. When acquiring specific color information from the image data stored in the image memory 580, the controlling section (acquiring section and determining section) 920 determines whether the destination such as a facsimile number received through the operation panel 161 of the operation section 160 is registered in the destination information stored in the storage section 970 or not. When the destination is not registered, the controlling section 920 issues an output stop instruction for the specific color to the color restricting section (extracting section) 510.

When the facsimile number of the destination is registered in the destination information in the storage section 970, no output stop instruction for the specific color is issued to the color restricting section 510. Thus, the color restricting section 510 does not delete the specific color, so that the image data received by the image memory 580 is transmitted intactly by facsimile, for example, as shown in FIG. 19C. When the facsimile number of the destination is not registered in the destination information in the storage section 970, the controlling section 920 issues an output stop instruction to the color restricting section 510. Thus, the color restricting section 510 deletes the specific color (and the specific color information), so that the image data in which the specific color portion (and the specific color information) has been deleted is transmitted by facsimile, for example, as shown in FIG. 19B.

Since the specific color portion is transmitted solely to the destination having been registered in advance, the confidential portion is prevented from leaking out, so that the security is improved. Further, the specific color added to the received image data is acquired, so that the acquired specific color is deleted. This permits the changing of the specific color for each piece of the image data. Thus, the color used in the confidential portion can be selected arbitrarily. This improves the user's convenience in document preparation.

### Embodiment 12

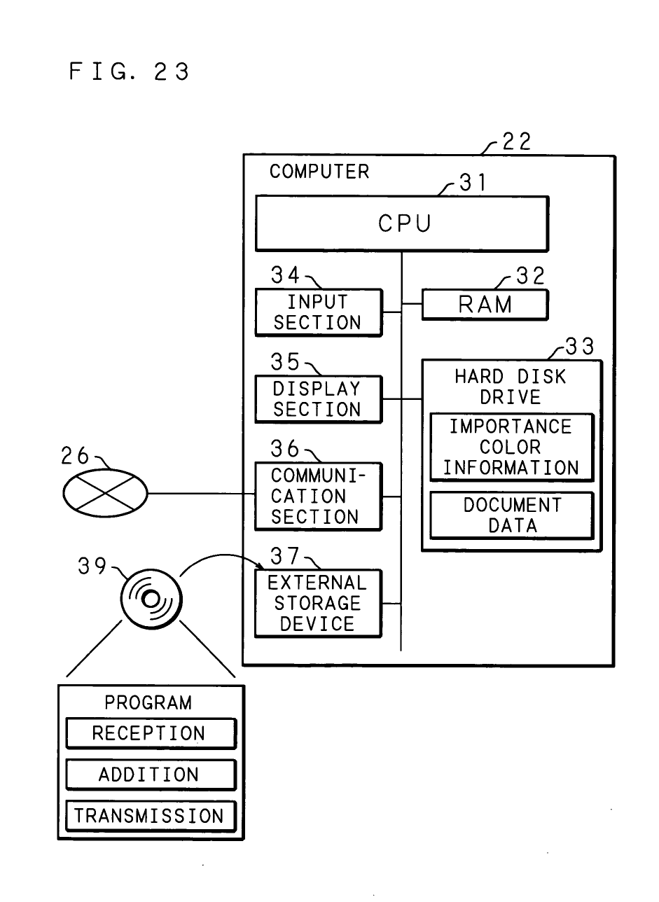

FIG. 23 is a block diagram showing an example of configuration of a computer (information processing apparatus) 22 connected to the above-mentioned image processing apparatus 50, 70, 80, or 90 according to the invention. This configuration is similar to that of the computer 22 of FIG. 13.

The hard disk drive 33 stores importance color information (specific color information) concerning the importance color (specific color) specified individually by the user. The importance color information may be received from the input section (reception section) 34 or the like. When receiving from the input section 34 a printout instruction for document data stored in the hard disk drive 33, the CPU 31 serves as means (adding means) for adding to the image data the specific color information where the importance color in the document data to be printed out is set as the specific color on the basis of the importance color information stored in the hard disk drive 33. The image data processed by this addition is transmitted from the communication section (transmitting section) 36 to the image processing apparatus 50, 70, 80, or 90.

For example, a bar code (specific color information) corresponding to the specific color may be added to the image data. Alternatively, a pattern (specific color information) corresponding to the specific color may be added to the image data by using a color hardly visible to human eyes. Further alternatively, the image data may be slightly changed in correspondence to the specific color information. Further, for the purpose of ensured recognition, the specific color information may be added at a fixed position such as an edge of the image data. For example, the CPU 31 may add a bar code corresponding to the specific color to the image data on the basis of the correspondence relation between the bar code and the specific color stored in the hard disk drive 33 in advance. Further, the CPU 31 may add a pattern corresponding to the specific color or may perform changing corresponding to the specific color, on the basis of the correspondence relation between the type of the pattern or the change and the specific color stored in the hard disk drive 33 in advance.

For example, a computer program recorded in a recording medium 39 such as a CD-ROM is read out by the external storage device 37 and then stored into the hard disk drive 33. After that, the computer program is loaded onto the RAM 32 and then executed on the CPU 31. Such a method allows the CPU 31 to serve as each piece of the above-mentioned means. The computer program may be received from another device by the communication section 36, and then stored into the hard disk drive 33.

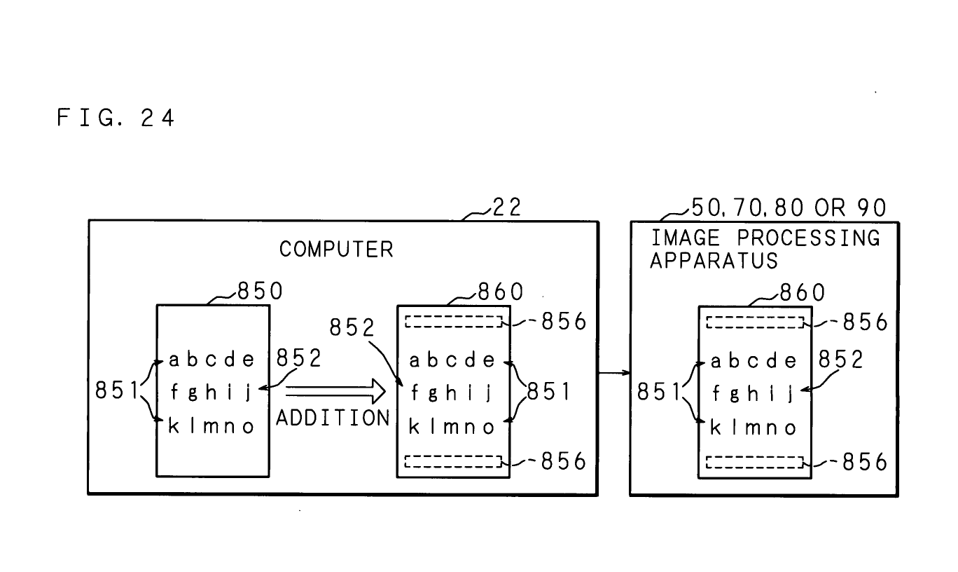

FIG. 24 is a diagram showing an example of printout of document data. For example, when the color (importance color) of an important portion (confidential portion) 852 of the document data 850 is blue, and when the color of the non-important portion 851 is black, the CPU 31 of the computer 22 adds to the image data 860 the specific color information (specific color information portion 856) where the importance color based on the importance color information is set as the specific color, as described above. The image data 860 to which the specific color information is added by the CPU 31 is transmitted from the communication section 36 to the image processing apparatus 50, 70, 80, or 90. In the image processing apparatus 50, 70, 80, or 90, for example, when the authentication is failed, the image data in which specific color (importance color) portion 852 (and the specific color information portion 856) has been deleted is printed out.

The importance color information stored in the hard disk drive 33 can be updated by the CPU 31, for example, in response to an operation through the input section 34. The user preparing the document data by using the computer 22 can use as the specific color an arbitrary importance color used in the important portion of the image data to be transmitted to the image processing apparatus 50, 70, 80, or 90. Thus, the printout can be performed in a desired color arrangement. This increases the degree of freedom in document preparation, and hence improves the convenience.

In Embodiment 12, the importance color specified individually by each user is used as the specific color, so that the image processing apparatus 50, 70, 80, or 90 deleted the specific color (importance color). However, the CPU 31 of the computer 22 may convert the importance color into the deletion color. For example, when the printout is performed onto white paper, the importance color portion (specific color portion) may be converted into white (the deletion color). When the specific color portion is converted into the deletion color by the computer 22, the image processing apparatus 50, 70, 80, or 90 does not need to delete the specific color. This reduces the load of output processing in the image processing apparatus 50, 70, 80, or 90.

Further, under the control of the CPU 31, an output instruction or an output stop instruction for the specific color (importance color) portion may be received from the input section 34, and then transmitted from the communication section 36 to the image processing apparatus 50, 70, 80, or 90. Such a case that the image processing apparatus 50, 70, 80, or 90 receives image data containing a specific color portion from the computer 22 and then prints out the image data occurs often when a user preparing a confidential or important document containing a specific color portion by using the computer 22 is printing out the document for the check of the contents. Thus, for user's convenience, as for the printout data received from the computer 22, the controlling section 520, 720, or 920 of the image processing apparatus 50, 70, 80, or 90 may switch the printing or the printout stopping of the specific color portion in response to an output instruction or an output stop instruction from the computer 22.

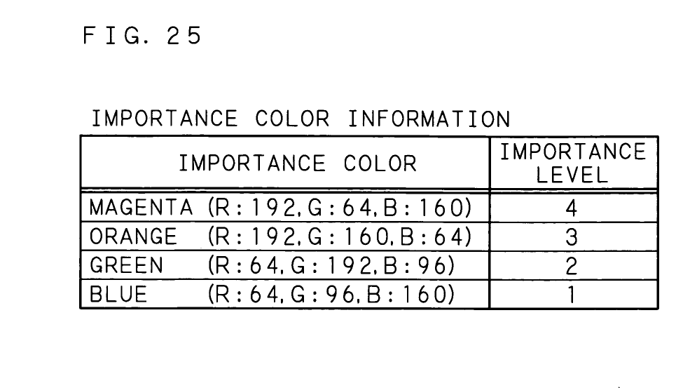

In Embodiments 9-12 described above, a plurality of specific colors (importance colors) may be used. In this case, any one from a plurality of the importance colors can be used. This improves the user's convenience. Further, an importance level may be set for each of a plurality of the importance colors, so that an importance color (specific color) corresponding the importance level may be used. FIG. 25 is a diagram showing an example of importance color information in which importance levels (confidentiality levels) are set. In the example of FIG. 25, the importance colors of magenta, orange, green, and blue are set in the descending order of importance level. On the basis of the importance color information, the CPU 31 may set a color corresponding to the importance level to be the specific color. Since the specific color is set in correspondence to the importance level, the user's convenience is improved in document preparation and outputting. For example, when importance level “3” is set to an underlined portion in a document, the specific color of orange may be set to the underlined portion. In this case, the CPU 31 converts the color of the underlined portion into orange, and then registers the orange color to the specific color information.

### Embodiment 13

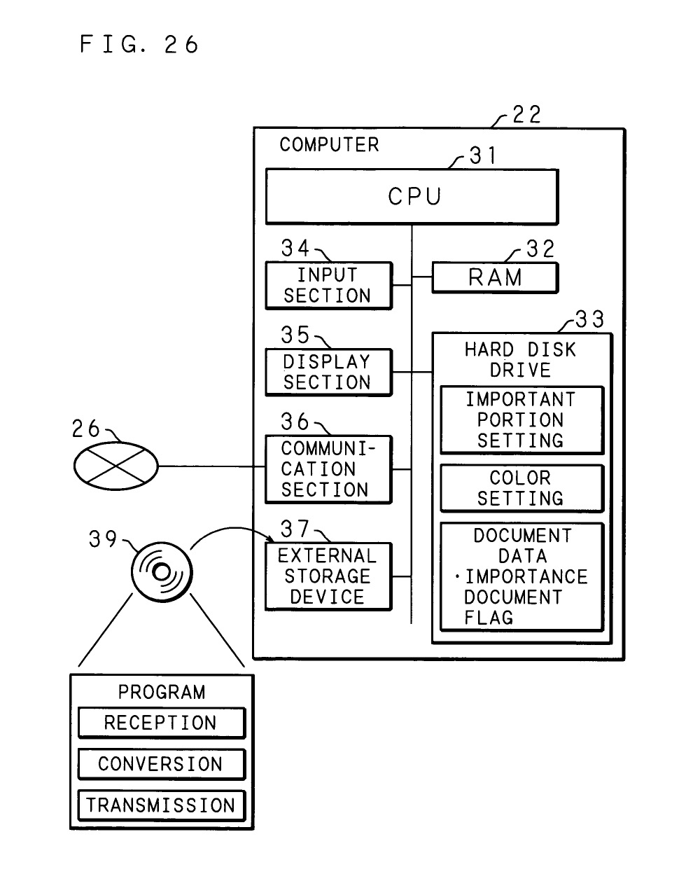

FIG. 26 is a block diagram showing an example of configuration of a computer 22 connected to the above-mentioned image processing apparatus 50, 70, 80, or 90. The computer 22 has a configuration similar to that of the computer 22 shown in FIG. 13 or 23. In the present embodiment, the hard disk drive 33 stores document data to which an importance document flag (for example, flag “1” indicates an important document, while flag “0” indicates a non-important document) for indicating the presence or absence of an important portion (confidential portion) is added. The hard disk drive 33 stores also important portion setting concerning the setting of the important portion in the document data. On the basis of the important portion setting, the CPU 31 adds specific color information where the color of the important portion in the document data is set to be the specific color.

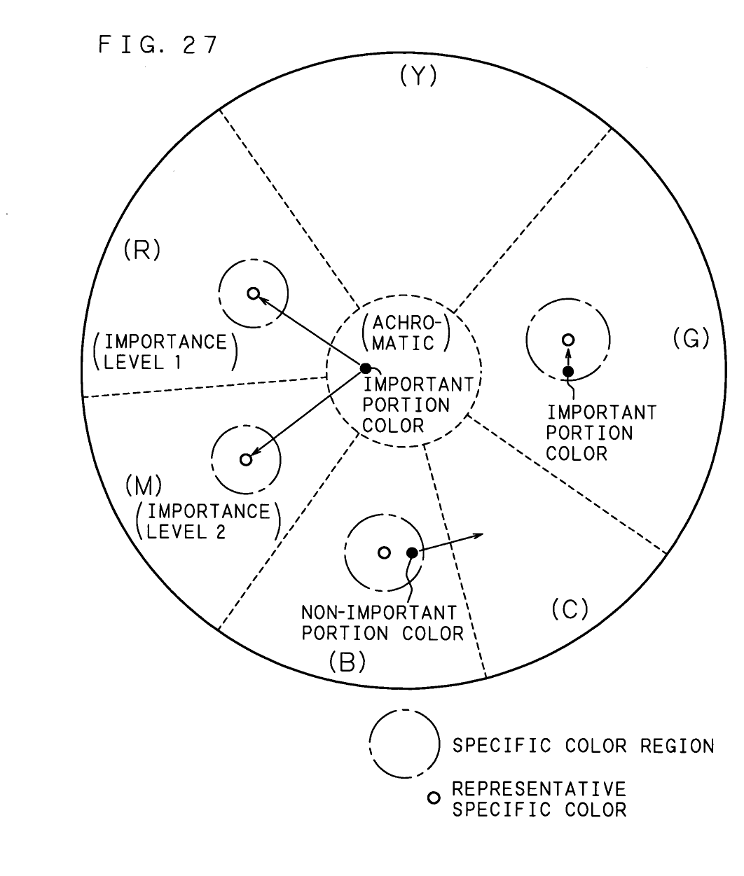

The specific color may be specified within a somewhat spread region. FIG. 27 is a color map diagram showing schematically the distribution of the colors used by the computer 22. In the example of FIG. 27, the color distribution is generally divided into the areas of R (red), Y (yellow), G (green), C (cyan), B (blue), M (magenta), and achromatic (achromatic color). For example, when the specific color belongs to the G area, a specific color region including the representative specific color within the G area may be treated as the specific color. Various setting information concerning the color map, such as the setting information of each color area, the setting information of the representative specific color, and the setting information of the specific color region, is stored in advance in the hard disk drive 33 or the like.

In the important portion, the importance color may be specified. Alternatively, a predetermined font or style such as an underlined portion and an italic font portion may be specified. In this case, for example, the CPU 31 may assign an importance level shown in FIG. 25 to the underlined portion or the italic font portion, so that the importance color corresponding to the assigned importance level is set to be the specific color. The hard disk drive 33 stores color setting concerning the color (specific color) used in the important portion and concerning the conversion of the color.

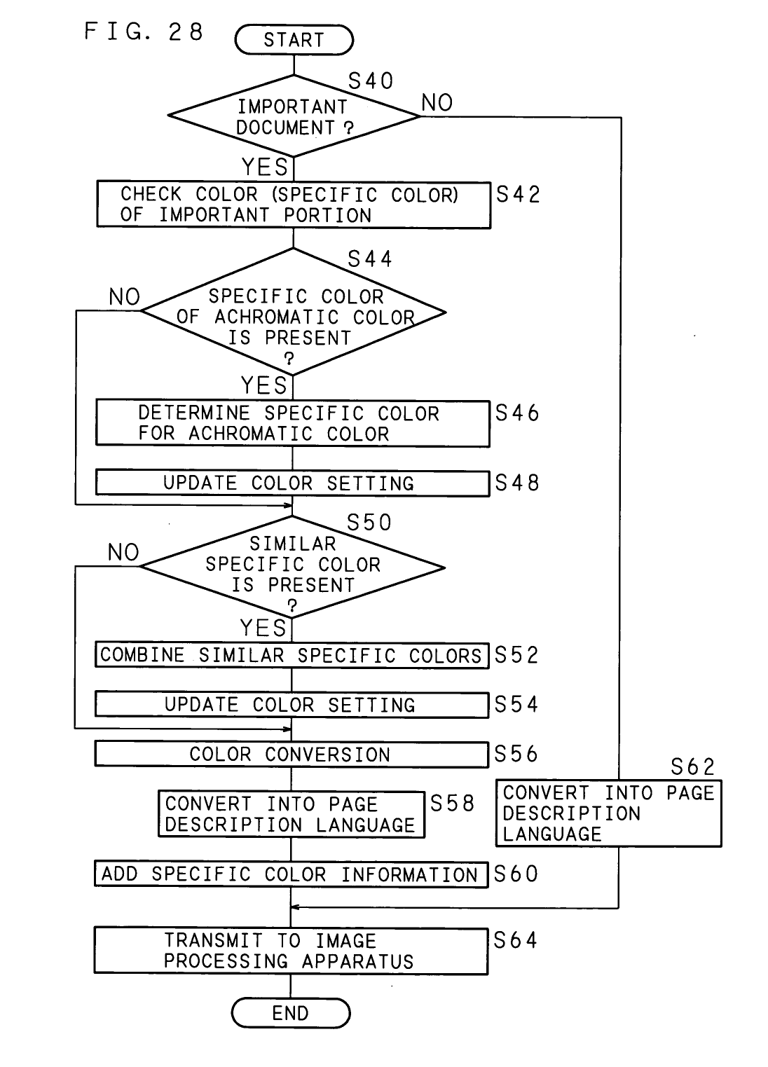

FIG. 28 is a flowchart showing an example of procedure of adding specific color information. When receiving from the input section 34 a printout instruction for the document data stored in the hard disk drive 33, the CPU 31 reads out the to-be-printed-out document data stored in the hard disk drive 33, and checks the importance document flag of the read-out document data. In case of a non-important document (importance flag=“0”) (S40: NO), the CPU 31 converts the document data into a page description language (S62), and then stores the data into the RAM 32 or the hard disk drive 33. The data is then transmitted from the communication section 36 to the image processing apparatus 50, 70, 80, or 90 (S64).

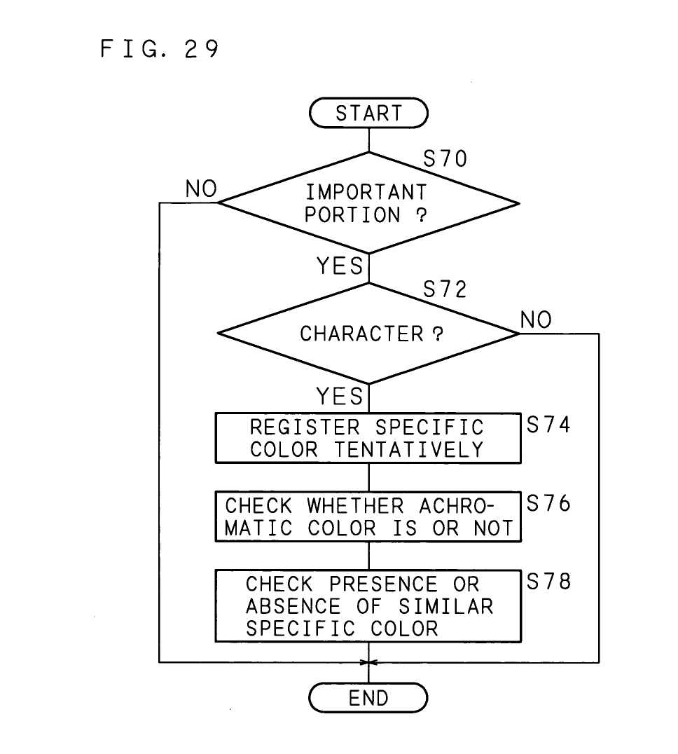

In case of an important document (importance flag=“1”) (S40: YES), the CPU 31 checks the color (specific color) of the important portion (S42). FIG. 29 is a flowchart showing an example of procedure of checking the color of an important portion. The CPU 31 determines whether each portion (each object) in the document data is an important portion or not, on the basis of the important portion setting. For example, when red is specified for the important portion in the important portion setting, the CPU 31 determines whether each portion is an important portion or not, on the basis of whether the color is red or not. Further, when an underline is specified for the important portion, the CPU 31 can determine whether each portion is an important portion or not, on the basis of the presence or absence of an underline.

In case of a non-important portion (S70: NO), the procedure is terminated. In case of an important portion (S70: YES), the CPU 31 determines whether the portion is a character portion or not. For example, the CPU 31 can discriminate a character portion from a graphics portion by means of an OCR. For example, in case of a graphics portion other than a character portion (S72: NO), the procedure is terminated. In case of a character portion (S72: YES), the CPU 31 tentatively registers the color (specific color) of the important portion to the color setting (S74), then checks whether the color is achromatic or not (S76), and then checks the presence or absence of a similar specific color (S78). For example, the CPU 31 checks whether the color of the important portion is included in the achromatic region or not, or alternatively whether the color of the important portion is included in another specific color region or not. The CPU 31 stores the result of determination into the RAM 32. The procedure shown in FIG. 29 is performed on each portion (each object) in the document data.

After the check (S42 in FIG. 28) of the color (specific color) of the important portion, when an important (specific color) portion of achromatic color is present (S44: YES), the CPU 31 determines a specific color for the achromatic color (S46), and then updates the color setting on the basis of this determination (S48). For example, as shown in FIG. 27, depending on the importance level, the CPU 31 may select a specific color in the R region or a specific color in the M region as the specific color for the important portion in an achromatic color region, so as to add this color to the color setting. The importance level may be specified through the input section 34. In case of no such specification, the CPU 31 may select the higher one of the importance levels.

When a specific color similar to the color (specific color) of the important portion is present (S50: YES), the CPU 31 combines similar specific colors (S52), so as to update the color setting on the basis of this combining (S54). For example, as shown in FIG. 27, when the color (specific color) of the important portion is included in a specific color region in the G region, the CPU 31 may generate a setting that the color of the important portion is converted into (combined with) the representative specific color in the G region, and then adds this setting to the color setting.

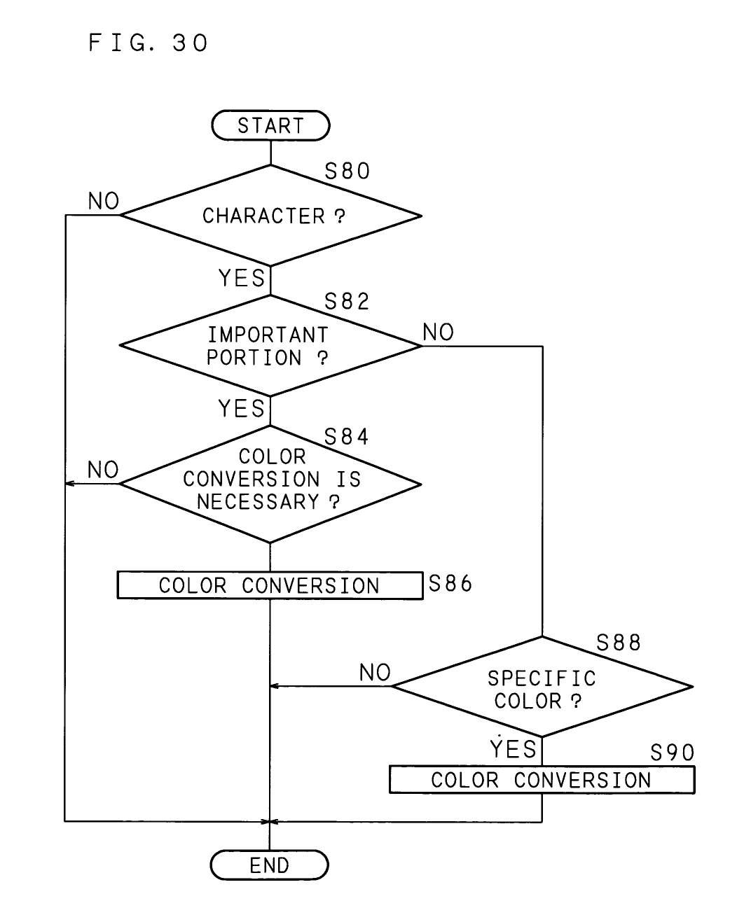

After that, on the basis of the color setting, the CPU 31 converts the color in the document data (S56). FIG. 30 is a flowchart showing an example of procedure of converting the color in document data. The CPU 31 determines whether each portion (each object) in the document data is a character portion or not. In case of a non-character portion (S80: NO), the procedure is terminated. In case of a character portion (S80: YES), the CPU 31 determines whether the portion is an important portion or not, on the basis of the important portion setting. In case of an important portion (S82: YES), the CPU 31 determines whether color conversion is necessary or not, on the basis of the color setting. In case that the color conversion is necessary (S84: YES), color conversion is performed on the basis of the color setting (S86). For example, an important portion of achromatic color may be converted into a specific color of a chromatic color on the basis of the color setting. Alternatively, when the color of an important portion is similar to another specific color, the color of the important portion may be converted into another specific color.

In case of a non-important portion (S82: NO), the CPU 31 determines whether the portion is in a specific color or not, on the basis of the color setting. In case of a specific color (S88: YES), color conversion is performed on the basis of the color setting (S90). For example, as shown in FIG. 27, the color of the non-important portion within the B region is included in the specific color, the color of the non-important portion may be converted into a color other than the specific color. In case that the color conversion is unnecessary (S84: NO), or alternatively in case that the portion is not in a specific color (S88: NO), the procedure is terminated. The procedure shown in FIG. 30 is performed on each portion (each object) in the document data.

After the color conversion (S56 in FIG. 28) for the document data, the CPU 31 converts the document data into a page description language (S58), and then stores the data into the RAM 32 or the hard disk drive 33. Specific color information concerning the specific color based on the color setting is added to the image data (S60). The data is then transmitted from the communication section 36 to the image processing apparatus 50, 70, 80, or 90 (S64).

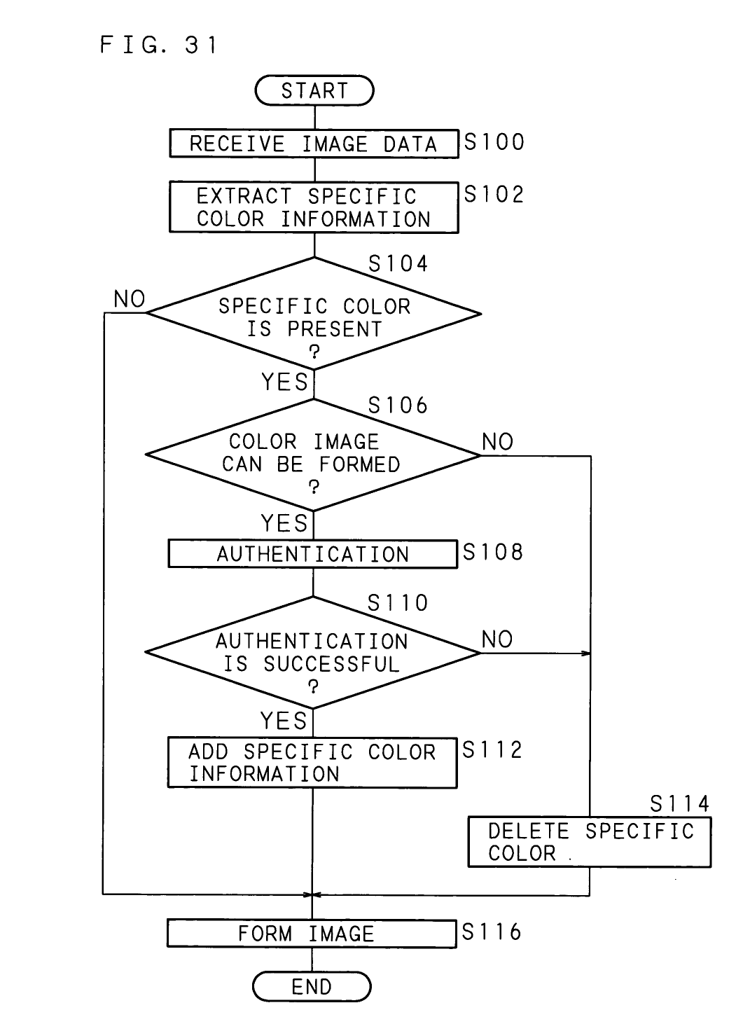

When receiving the document data (image data) transmitted from the computer 22, the image processing apparatus 50 or the like performs the image formation (printout) of the document data. FIG. 31 is a flowchart showing an example of procedure of image formation in the image processing apparatus 50. The image data received by the communication section 150 (S100) is stored into the image memory 580 under the control of the controlling section 520. At the same time, specific color-information is extracted (S102). In case that no specific color is present (S104: NO), the image formation of the received image data is performed under the control of the controlling section 520 (S116).

In the case that a specific color is present (S104: YES) and that a color image can be formed (S106: YES), the controlling section 520 performs authentication (S108). When the authentication is successful (S10: YES), the controlling section 520 adds specific color information to the image data (S112) (or alternatively, does not delete the specific color information), and then performs image formation (S116). In the case that a color image cannot be formed (S106: NO) or alternatively that the authentication is failed (S110: NO), the color restricting section 510 deletes the specific color (and the specific color information) (S114) under the control of the controlling section 520, and then image formation is performed (S116).

In the above-mentioned embodiment, at the same time as the specific color information is added to the image data (S60 in FIG. 28), the CPU 31 may add authentication information to the image data. When the authentication information is added to the image data in a similar manner to the case of specific color information, the controlling section 520, 720, or 920 of the image processing apparatus 50, 70, 80, or 90 can extract the authentication information similarly to the case of specific color information, so as to perform authentication. When the authentication information is added to the image data, the necessity of inputting a password or the like is avoided. This improves the user's convenience. Further, plural pieces of authentication information may be added depending on the importance level (confidentiality level).

In case of a non-important (non-confidential) document, at the same time as the computer 22 converts the document data into a page description language (S62 in FIG. 28), the CPU 31 may add specific color information indicating the absence of a specific color, to the image data. In the image processing apparatus 50, 70, 80, or 90, in the case that no specific color is present (S104: NO in FIG. 31) or alternatively that a specific color has been deleted (S114 in FIG. 31), specific color information indicating the absence of a specific color may be added to the image data under the control of the controlling section 520, 720, or 920. When the specific color information indicating the absence of a specific color is added to the image data, the absence of a specific color is clearly notified. Thus, for example, when no specific color information cannot be extracted despite that a specific color is specified, this approach avoids misunderstanding as if no specific color were specified.

A user preparing the document data by using the computer 22 can specify arbitrarily the color (specific color) of the important portion of the image data to be: transmitted, so as to transmit the specified specific color to the image processing apparatus 50; 70, 80, or 90. Thus, the printout can be performed in a desired color arrangement. This increases the degree of freedom in document preparation, and hence improves the convenience. Further, for example, when an important portion of achromatic color is converted into a chromatic specific color, ordinary colors such as black are prevented from being specified as a specific color. Further, when the color of a non-important portion in a specific color region is converted into a non-specific color, the non-important portion is prevented from being converted into a specific color by mistake.

Embodiments 9-13 described above have the following effects. That is, specific color information concerning the specific color of the image data to be outputted is acquired by the image processing apparatus, so that the acquired specific color is outputted or output-stopped depending on the result of authentication. This avoids that the copying, printing, or facsimile transmission of a document containing a confidential (specific color) portion is carried out by many and unspecified persons. Further, the specific color can be changed flexibly, and hence the user's convenience is improved in document preparation and document outputting.

Further, specific color information concerning the specific color of the image data to be outputted is acquired by the image processing apparatus, so that the specific color is outputted or output-stopped depending on the destination. This avoids the transmission of a confidential (specific color) portion to many and unspecified destinations. Further, the specific color can be changed flexibly, and hence the user's convenience is improved in document preparation and document outputting. Furthermore, the determination such as authentication for determining the outputting or the output stopping of the specific color portion and the extraction of the specific color portion can be performed in parallel. This permits efficient output processing of the image data. Furthermore, since specific color information is added to the image data to be outputted, the necessity of specifying of a specific color in addition to the transmission of the image data is avoided. Further, mistakes and missing are avoided in the specifying of the specific color.

A plurality of specific colors can be used. This increases the universality (redundancy) in the colors used as specific colors, and hence improves the convenience in document preparation. Further, an importance level may be set for each specific color, so that the specific color used for the output stop may be changed depending on the importance level. This improves the user's convenience. Further, in the transmission of the image data to the image processing apparatus, specific color information concerning the specific color of the image data may be received and then transmitted. This allows the user to set the specific color flexibly, and hence improves the convenience in document preparation and document outputting. Furthermore, image data to which specific color information concerning the specific color has been added can be transmitted to the image processing apparatus. This allows the user to change the specific color flexibly, and hence improves the convenience in document preparation and document outputting.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image processing method which uses an image processing apparatus for receiving color image data so as to store the data into a storage section and then performing the output processing of the color image data stored in said storage section, said method comprising the steps of:
authenticating the requestor of the output processing of the received color image data;
extracting a specific color portion of the received color image data, when the authentication is not completed; and
stopping the output of the extracted specific color portion.

2. An image processing method which uses an image processing apparatus for receiving color image data so as to store the data into a storage section and then performing the output processing of the color image data stored in said storage section, said method comprising the steps of:
authenticating the requestor of the output processing of the received color image data;
extracting a specific color portion of the received color image data; and
stopping the output of the extracted specific color portion, when the authentication is not completed.

3. An image processing method which uses an image processing apparatus for receiving color image data so as to store the data into a storage section and then performing the output processing of the color image data stored in said storage section or alternatively the output processing with the exclusion of a specific color, said method comprising the steps of:
acquiring specific color information concerning the specific color of the received color image data;
authenticating the requestor of the output processing of the color image data the specific color information of which is acquired;
extracting a specific color portion of the received color image data, when the authentication is failed; and
stopping the output of the extracted specific color portion.

4. An image processing method which uses an image processing apparatus for receiving color image data so as to store the data into a storage section and then performing the output processing of the color image data stored in said storage section or alternatively the output processing with the exclusion of a specific color, said method comprising the steps of:
acquiring specific color information concerning the specific color of the received color image data;
authenticating the requestor of the output processing of the color image data the specific color information of which is acquired;
extracting a specific color portion of the received color image data; and
stopping the output of the extracted specific color portion, when the authentication is failed.

5. An image processing apparatus for receiving color image data so as to store the data into a storage section and then performing the output processing of the color image data stored in said storage section, said apparatus comprising:
an authenticating section for authenticating the requester of the output processing of the received color image data;
an extracting section for extracting a specific color portion of the received color image data, when the authentication is not completed in said authenticating section; and
an output stopping section for stopping the output of the specific color portion extracted by said extracting section.

6. An image processing apparatus for receiving color image data so as to store the data into a storage section and then performing the output processing of the color image data stored in said storage section, said apparatus comprising:
an authenticating section for authenticating the requestor of the output processing of the received color image data;
an extracting section for extracting a specific color portion of the received color image data; and
an output stopping section for stopping the output of the specific color portion extracted by said extracting section, when the authentication is not completed in said authenticating section.

7. An image processing apparatus for receiving color image data so as to store the data into a storage section and then performing the output processing of the color image data stored in said storage section, said apparatus comprising:
an instruction receiving section for receiving an output instruction or an output stop instruction for a specific color portion of the received color image data;
an extracting section for extracting the specific color portion of the received color image data, when said instruction receiving section receives the output stop instruction; and
an output stopping section for stopping the output of the specific color portion extracted by said extracting section.

8. An image processing apparatus for receiving color image data so as to store the data into a storage section and then performing the output processing of the color image data stored in said storage section, said apparatus comprising:
an instruction receiving section for receiving an output instruction or an output stop instruction for a specific color portion of the received color image data;
an extracting section for extracting the specific color portion of the received color image data; and
an output stopping section for stopping the output of the specific color portion extracted by said extracting section, when said instruction receiving section receives the output stop instruction.

9. An image processing apparatus according to claim 5, wherein
said storage section comprises: a semiconductor storage device for storing the specific color portion of the received image data; and a magnetic storage device for storing a non-specific color portion other than the specific color portion of the received image data.

10. An image processing apparatus according to claim 6, wherein
said storage section comprises: a semiconductor storage device for storing the specific color portion of the received image data; and a magnetic storage device for storing a non-specific color portion other than the specific color portion of the received image data.

11. An image processing apparatus according to claim 7, wherein
said storage section comprises: a semiconductor storage device for storing the specific color portion of the received image data; and a magnetic storage device for storing a non-specific color portion other than the specific color portion of the received image data.

12. An image processing apparatus according to claim 8, wherein
said storage section comprises: a semiconductor storage device for storing the specific color portion of the received image data; and a magnetic storage device for storing a non-specific color portion other than the specific color portion of the received image data.

13. An image processing apparatus according to claim 5, further comprising
a deleting section for deleting the specific color portion which is stored in said storage section and the output processing of which is completed, once the output processing is completed.

14. An image processing apparatus according to claim 6, further comprising
a deleting section for deleting the specific color portion which is stored in said storage section and the output processing of which is completed, once the output processing is completed.

15. An image processing apparatus according to claim 7, further comprising
a deleting section for deleting the specific color portion which is stored in said storage section and the output processing of which is completed, once the output processing is completed.

16. An image processing apparatus according to claim 8, further comprising
a deleting section for deleting the specific color portion which is stored in said storage section and the output processing of which is completed, once the output processing is completed.

17. An image processing apparatus according to claim 5, further comprising
an encrypting section for encrypting the specific color portion to be stored into said storage section.

18. An image processing apparatus according to claim 6, further comprising
an encrypting section for encrypting the specific color portion to be stored into said storage section.

19. An image processing apparatus according to claim 7, further comprising
an encrypting section for encrypting the specific color portion to be stored into said storage section.

20. An image processing apparatus according to claim 8, further comprising
an encrypting section for encrypting the specific color portion to be stored into said storage section.

21. An image processing apparatus according to claim 5, further comprising
a specific color reception section for receiving the specification of a specific color.

22. An image processing apparatus according to claim 6, further comprising
a specific color reception section for receiving the specification of a specific color.

23. An image processing apparatus according to claim 7, further comprising
a specific color reception section for receiving the specification of a specific color.

24. An image processing apparatus according to claim 8, further comprising
a specific color reception section for receiving the specification of a specific color.

25. An image processing apparatus according to claim 5, wherein
a plurality of colors are used as said specific color.

26. An image processing apparatus according to claim 6, wherein
a plurality of colors are used as said specific color.

27. An image processing apparatus according to claim 7, wherein
a plurality of colors are used as said specific color.

28. An image processing apparatus according to claim 8, wherein
a plurality of colors are used as said specific color.

29. An image processing apparatus according to claim 25, wherein
importance levels are set for said specific colors.

30. An image processing apparatus according to claim 26, wherein
importance levels are set for said specific colors.

31. An image processing apparatus according to claim 27, wherein
importance levels are set for said specific colors.

32. An image processing apparatus according to claim 28, wherein
importance levels are set for said specific colors.

33. An image processing apparatus according to claim 5, wherein
said specific color portion is a character portion in a specific color.

34. An image processing apparatus according to claim 6, wherein
said specific color portion is a character portion in a specific color.

35. An image processing apparatus according to claim 7, wherein
said specific color portion is a character portion in a specific color.

36. An image processing apparatus according to claim 8, wherein
said specific color portion is a character portion in a specific color.

37. An image processing apparatus according to claim 5, wherein
said specific color portion is a graphics portion containing a specific color.

38. An image processing apparatus according to claim 6, wherein
said specific color portion is a graphics portion containing a specific color.

39. An image processing apparatus according to claim 7, wherein
said specific color portion is a graphics portion containing a specific color.

40. An image processing apparatus according to claim 8, wherein
said specific color portion is a graphics portion containing a specific color.

41. An image processing apparatus according to claim 5, wherein
said output stopping section replaces the specific color portion with a predetermined mark.

42. An image processing apparatus according to claim 6, wherein
said output stopping section replaces the specific color portion with a predetermined mark.

43. An image processing apparatus according to claim 7, wherein
said output stopping section replaces the specific color portion with a predetermined mark.

44. An image processing apparatus according to claim 8, wherein
said output stopping section replaces the specific color portion with a predetermined mark.

45. An image processing apparatus according to claim 5, further comprising
a notifying section for notifying the output stop of the specific color portion, when the output of the specific color portion is stopped.

46. An image processing apparatus according to claim 6, further comprising
a notifying section for notifying the output stop of the specific color portion, when the output of the specific color portion is stopped.

47. An image processing apparatus according to claim 7, further comprising
a notifying section for notifying the output stop of the specific color portion, when the output of the specific color portion is stopped.

48. An image processing apparatus according to claim 8, further comprising
a notifying section for notifying the output stop of the specific color portion, when the output of the specific color portion is stopped.

49. An image processing apparatus for receiving color image data so as to store the data into a storage section and then performing output processing including the transmission of the color image data stored in said storage section, said apparatus comprising:
a destination storing section for storing a destination to which the transmission of a specific color portion of the received color image data is allowed;
an extracting section for extracting the specific color portion of the received color image data, when the destination of the received color image data is not stored in said destination storing section; and
an output stopping section for stopping the output of the specific color portion extracted by said extracting section.

50. An image processing apparatus for receiving color image data so as to store the data into a storage section and then performing output processing including the transmission of the color image data stored in said storage section, said apparatus comprising:
a destination storing section for storing a destination to which the transmission of a specific color portion of the received color image data is allowed;
an extracting section for extracting the specific color portion of the received color image data; and
an output stopping section for stopping the output of the specific color portion extracted by said extracting section, when the destination of the received color image data is not stored in said destination storing section.

51. An image processing apparatus according to claim 5, wherein
said output processing includes the transmission of the image data, and wherein
said apparatus further comprises an encrypting section for encrypting the specific color portion of the image data to be transmitted.

52. An image processing apparatus according to claim 6, wherein
said output processing includes the transmission of the image data, and wherein
said apparatus further comprises an encrypting section for encrypting the specific color portion of the image data to be transmitted.

53. An image processing apparatus according to claim 7, wherein
said output processing includes the transmission of the image data, and wherein
said apparatus further comprises an encrypting section for encrypting the specific color portion of the image data to be transmitted.

54. An image processing apparatus according to claim 8, wherein
said output processing includes the transmission of the image data, and wherein
said apparatus further comprises an encrypting section for encrypting the specific color portion of the image data to be transmitted.

55. An image processing apparatus according to claim 49, wherein
said output processing includes the transmission of the image data, and wherein
said apparatus further comprises an encrypting section for encrypting the specific color portion of the image data to be transmitted.

56. An image processing apparatus according to claim 50, wherein
said output processing includes the transmission of the image data, and wherein
said apparatus further comprises an encrypting section for encrypting the specific color portion of the image data to be transmitted.

57. An image processing apparatus according to claim 5, further comprising
a transmitting section for transmitting specific color information concerning the specific color.

58. An image processing apparatus according to claim 6, further comprising
a transmitting section for transmitting specific color information concerning the specific color.

59. An image processing apparatus according to claim 7, further comprising
a transmitting section for transmitting specific color information concerning the specific color.

60. An image processing apparatus according to claim 8, further comprising
a transmitting section for transmitting specific color information concerning the specific color.

61. An image processing apparatus according to claim 49, further comprising
a transmitting section for transmitting specific color information concerning the specific color.

62. An image processing apparatus according to claim 50, further comprising
a transmitting section for transmitting specific color information concerning the specific color.

63. An image processing apparatus for receiving color image data so as to store the data into a storage section and then performing the output processing of the color image data stored in said storage section or alternatively the output processing with the exclusion of a specific color, said apparatus comprising:
an acquiring section for acquiring specific color information concerning the specific color of the received color image data;
an authenticating section for authenticating the requestor of the output processing of the color image data the specific color information of which is acquired by said acquiring section;
an extracting section for extracting a specific color portion of the received color image data, when the authentication is failed in said authenticating section; and
an output stopping section for stopping the output of the specific color portion extracted by said extracting section.

64. An image processing apparatus for receiving color image data so as to store the data into a storage section and then performing the output processing of the color image data stored in said storage section or alternatively the output processing with the exclusion of a specific color, said apparatus comprising:
an acquiring section for acquiring specific color information concerning the specific color of the received color image data;
an authenticating section for authenticating the requestor of the output processing of the color image data the specific color information of which is acquired by said acquiring section;
an extracting section for extracting a specific color portion of the received color image data; and
an output stopping section for stopping the output of the specific color portion extracted by said extracting section, when the authentication is failed in said authenticating section.

65. An image processing apparatus for receiving color image data so as to store the data into a storage section and then performing output processing including the transmission of the color image data stored in said storage section or alternatively the transmission with the exclusion of a specific color, said apparatus comprising:
an acquiring section for acquiring specific color information concerning the specific color of the received color image data;
a destination storing section for storing a destination to which the transmission of the specific color portion of the received color image data is allowed;
a determining section for determining whether the destination of the color image data the specific color information of which is acquired by said acquiring section is stored in said destination storing section or not;
an extracting section for extracting the specific color portion of the received color image data, when said determining section determines that the destination of the color image data is not stored in said destination storing section; and
an output stopping section for stopping the output of the specific color portion extracted by said extracting section.

66. An image processing apparatus for receiving color image data so as to store the data into a storage section and then performing output processing including the transmission of the color image data stored in said storage section or alternatively the transmission with the exclusion of a specific color, said apparatus comprising:
an acquiring section for acquiring specific color information concerning the specific color of the received color image data;
a destination storing section for storing a destination to which the transmission of the specific color portion of the received color image data is allowed;
a determining section for determining whether the destination of the color image data the specific color information of which is acquired by said acquiring section is stored in said destination storing section or not;
an extracting section for extracting the specific color portion of the received color image data; and
an output stopping section for stopping the output of the specific color portion extracted by said extracting section, when said determining section determines that the destination of the color image data is not stored in said destination storing section.

67. An image processing apparatus according to claim 63, wherein
said specific color information is added to the received image data, while said acquiring section acquires the specific color information added to the received image data.

68. An image processing apparatus according to claim 64, wherein
said specific color information is added to the received image data, while said acquiring section acquires the specific color information added to the received image data.

69. An image processing apparatus according to claim 65, wherein
said specific color information is added to the received image data, while said acquiring section acquires the specific color information added to the received image data.

70. An image processing apparatus according to claim 66, wherein
said specific color information is added to the received image data, while said acquiring section acquires the specific color information added to the received image data.

71. An image processing apparatus according to claim 63, wherein
a plurality of colors are used as said specific color.

72. An image processing apparatus according to claim 64, wherein
a plurality of colors are used as said specific color.

73. An image processing apparatus according to claim 65, wherein
a plurality of colors are used as said specific color.

74. An image processing apparatus according to claim 66, wherein
a plurality of colors are used as said specific color.

75. An image processing apparatus according to claim 71, wherein
importance levels are set for said specific colors.

76. An image processing apparatus according to claim 72, wherein
importance levels are set for said specific colors.

77. An image processing apparatus according to claim 73, wherein
importance levels are set for said specific colors.

78. An image processing apparatus according to claim 74, wherein
importance levels are set for said specific colors.

79. An information processing apparatus for transmitting image data to the image processing apparatus according to claim 5, said information processing apparatus comprising:
a reception section for receiving specific color information concerning a specific color; and
a converting section for converting into said specific color a predetermined color in the image data to be transmitted to said image processing apparatus.

80. An information processing apparatus for transmitting image data to the image processing apparatus according to claim 6, said information processing apparatus comprising:
a reception section for receiving specific color information concerning a specific color; and
a converting section for converting into said specific color a predetermined color in the image data to be transmitted to said image processing apparatus.

81. An information processing apparatus for transmitting image data to the image processing apparatus according to claim 7, said information processing apparatus comprising:
a reception section for receiving specific color information concerning a specific color; and
a converting section for converting into said specific color a predetermined color in the image data to be transmitted to said image processing apparatus.

82. An information processing apparatus for transmitting image data to the image processing apparatus according to claim 8, said information processing apparatus comprising:
a reception section for receiving specific color information concerning a specific color; and
a converting section for converting into said specific color a predetermined color in the image data to be transmitted to said image processing apparatus.

83. An information processing apparatus for transmitting image data to the image processing apparatus according to claim 49, said information processing apparatus comprising:
a reception section for receiving specific color information concerning a specific color; and
a converting section for converting into said specific color a predetermined color in the image data to be transmitted to said image processing apparatus.

84. An information processing apparatus for transmitting image data to the image processing apparatus according to claim 50, said information processing apparatus comprising:
a reception section for receiving specific color information concerning a specific color; and
a converting section for converting into said specific color a predetermined color in the image data to be transmitted to said image processing apparatus.

85. An information processing apparatus for transmitting image data to the image processing apparatus according to claim 63, wherein
said information processing apparatus comprises a reception section for receiving specific color information concerning a specific color of the image data to be transmitted, and wherein
said information processing apparatus transmits: the image data; and the specific color information received by said reception section.

86. An information processing apparatus for transmitting image data to the image processing apparatus according to claim 64, wherein
said information processing apparatus comprises a reception section for receiving specific color information concerning a specific color of the image data to be transmitted, and wherein
said information processing apparatus transmits: the image data; and the specific color information received by said reception section.

87. An information processing apparatus for transmitting image data to the image processing apparatus according to claim 65, wherein
said information processing apparatus comprises a reception section for receiving specific color information concerning a specific color of the image data to be transmitted, and wherein
said information processing apparatus transmits: the image data; and the specific color information received by said reception section.

88. An information processing apparatus for transmitting image data to the image processing apparatus according to claim 66, wherein
said information processing apparatus comprises a reception section for receiving specific color information concerning a specific color of the image data to be transmitted, and wherein
said information processing apparatus transmits: the image data; and the specific color information received by said reception section.

89. An information processing apparatus according to claim 85, further comprising
an adding section for adding the specific color information received by said reception section to the image data to be transmitted, wherein
said information processing apparatus transmits the image data to which the specific color information is added by said adding section.

90. An information processing apparatus according to claim 86, further comprising
an adding section for adding the specific color information received by said reception section to the image data to be transmitted, wherein
said information processing apparatus transmits the image data to which the specific color information is added by said adding section.

91. An information processing apparatus according to claim 87, further comprising
an adding section for adding the specific color information received by said reception section to the image data to be transmitted, wherein
said information processing apparatus transmits the image data to which the specific color information is added by said adding section.

92. An information processing apparatus according to claim 88, further comprising
an adding section for adding the specific color information received by said reception section to the image data to be transmitted, wherein
said information processing apparatus transmits the image data to which the specific color information is added by said adding section.
